(19) United States
(12) Patent Application Publication
(10) Pub. No.: US 2005/0120128 A1
(43) Pub. Date: Jun. 2, 2005

(54) Method and system of bandwidth management for streaming data

(75) Inventors: W. Paul Willes, Alpine, UT (US); Thomas R. Rohlfing, Salt Lake City, UT (US); Harold L. Simonsen, South Iordan, UT (US); Jeffrey B. Lancaster, Riverton, UT (US); Andrew I. Hartsfield, Draper, UT (US); Evan I. Tree, Sandy, UT (US); Paul S. Willes, South Jordan, UT (US)

Correspondence Address: Lloyd W. Sadler, Esq.;SNELL & WILMER, L.L.P., Gateway Tower West, 15 West South Temple, Suite 1200, Salt Lake City, UT, 84101, US

(73) Assignee: WiLife, Inc., Draper, UT (US)

(21) Appl. No.: 10/725,844

(22) Filed: Dec. 2, 2003

(51) Int. Cl. G06F 15/16

(52) U.S. Cl. 709/232

(57) ABSTRACT

A data networking system and method which allows efficient use of bandwidth for data streams such as video and audio. This invention allows network nodes to dynamically identify changing network conditions which are typical on wireless and power line networks. The system and method dynamically adapt to the changes which affect network bandwidth by changing compression rates, compression types, audio/video quality, motion masks, throughput for specific connections, or mass storage of data streams until the network is capable of sending the data. The result is an improved system that requires little or no user intervention as network conditions change.

### BACKGROUND OF INVENTION

1. Field of the Invention

This invention relates to electronic communications systems. More specifically this invention relates to data bandwidth management of electronic communications systems.

2. Description of Related Art

A variety of schemes have been used to provide reliable and efficient transportation of streaming data across a network. Typically, these schemes employ techniques that assume fixed bandwidth such as selectable compression ratios, selectable video resolution, selectable video frame rates, selectable audio quality etc. In addition, generally these schemes are typically designed for controlling bandwidth between two nodes, and not multiple nodes within a network. Moreover, these schemes are not typically designed for dynamically controlling and managing bandwidth for multiple streaming devices across networks such as power line or wireless networks where network conditions are potentially constantly changing.

Although these references may not constitute prior art, for general background material, the reader is directed to the following United States Patent Documents each of which is hereby incorporated by reference in its entirety for the material contained therein: U.S. Patent and Patent Application No. 2003/0107648, 2003/0043908, 2003/0112335, 2003/0039390, 2002/0158991, 2002/0018450, U.S. Pat. Nos. 6,611,503, 6,570,606, 6,522,352, 6,507,672, 6,337,928, 6,323,897, 6,205,499, 6,118,817, 6,091,777, 6,091,777, 6,088,360, 5,926,209, 5,793,416, 5,729,535.

### SUMMARY OF INVENTION

It is desirable to provide a system, for reliably sending streaming data across a network, which is efficient yet adaptable to changing network conditions.

Therefore it is the general object of an embodiment of this invention to provide a bandwidth management system and method for changing compression parameters between a network node and a master node based on network conditions.

It is an object of an embodiment of this invention to provide a bandwidth management system and method where data from one or more a data sources are compressed and/or the quality of the data source is changed based on network conditions from one or more network nodes and/or a master node.

It is a further object of an embodiment of this invention to provide a bandwidth management system and method where the network conditions cause compression parameters to change can be, but are not limited to obstructions, RF interference, changing network impedance, impedance mismatches, RF harmonics, multipath effects, various channel fading effects, network traffic volume, conducted noise, induced noise, self induced noise, friendly noise, intermodulation products, and the like.

It is a further object of an embodiment of this invention to provide a bandwidth management system and method for decompressing the data that was compressed by the compression module.

It is a further object of an embodiment of this invention to provide a bandwidth management system and method where the data source is a video source, an audio source, a computer data source, control data, a telephony source, and the like.

It is a further object of an embodiment of this invention to provide a bandwidth management system and method where an attribute of a data source is controlled from a data interface where the attribute can be brightness, contrast, hue, white balance, saturation, luminance decimation filtering, n tap interpolation horizontal scaling, n tap interpolation vertical scaling, and the like.

It is a further object of an embodiment of this invention to provide a bandwidth management system and method where the protocols that are used can be RTSP, RTP, RTCP, HTTP, ASF, FTP, DDNS, NTP TFTP, TCP/IP, UDP, DHCP, DNS, SMTP, HTML, LDAP, SNMP and SNTP.

It is a further object of an embodiment of this invention to provide a bandwidth management system and method where a motion detector is used to detect changes in a video source.

It is a further object of an embodiment of this invention to provide a bandwidth management system and method where the motion detector can use any of the following detection types: user determined, automatically learned, defined as geometric shapes, defined as non-geometric shapes, defined by regions, defined by object size, defined by object speed, defined by object micro movements, defined by object macro movements and the like.

It is a further object of an embodiment of this invention to provide access to a data source connected to a data interface where the data source can be a PAL composite, PAL component video, NTSC composite video, NTSC component video, S-video, serial, I²C, SPI, DVI, Digital Camera Interface, CCIR656, CCIR601, UTI656, UTI601, Parallel, and the like.

It is a further object of an embodiment of this invention to provide a bandwidth management system and method where mass storage is used in a network node and/or master nodes to store off data from a data source based on network conditions.

It is a further object of an embodiment of this invention to provide a bandwidth management system and method where network nodes and/or master nodes use a type of mass storage such as a hard disk, a flash memory, a random access memory, a floppy disk, and the like to store off data from a data source.

It is a further object of an embodiment of this invention to provide a bandwidth management system and method where the data source is encrypted as it is sent over a local and/or external network.

It is a further object of an embodiment of this invention to provide a bandwidth management system and method where the encryption can be DES, Triple DES, AES, RC4, RC5, 56 Bit, 64 Bit, 128 Bit, RSA, and the like.

It is a further object of an embodiment of this invention to provide a bandwidth management system and method where network nodes and master nodes can be administered using a web server.

It is a further object of an embodiment of this invention to provide a bandwidth management system and method where an application program uses data from a data source.

It is a further object of an embodiment of this invention to provide a bandwidth management system and method where an external network is connected to the system for administering, viewing and/or listening to data sources.

It is a further object of an embodiment of this invention to provide a bandwidth management system and method where the external network can be the Internet, a Local Area Network (LAN), a Wide Area Network (WAN), and the like.

It is a further object of an embodiment of this invention to provide a bandwidth management system and method where the compression parameters are MJPEG, MPEG1, MPEG2, MPEG4, MPEG7, MPEG10, H.263, H.264, H.323, MP3, AC-3, wavelet compression, compression with post smoothing techniques, and the like.

It is a further object of an embodiment of this invention to provide a bandwidth management system and method where the local network is a power line network, a wireless network, an acoustic network, a wired network, an optic network and the like.

It is a further object of an embodiment of this invention to provide a bandwidth management system and method where a device is connected to a master node which can be a personal computer, a telephone, an e-mail system, a monitor, a Digital Video Recorder, a PDA, and the like.

It is a further object of an embodiment of this invention to provide a bandwidth management system and method where a device is connected to a master node via a residential gateway, which can be a personal computer, a telephone, an e-mail system, a monitor, a Digital Video Recorder, a PDA, and the like.

It is a further object of an embodiment of this invention to provide a bandwidth management system and method where a signal is generated based on changes in the data source and where the signal is sent in the form of an e-mail, a text message, a voice message, a lighting control message, a video control message, a home control message, an audio control message, and the like.

It is a further object of an embodiment of this invention to provide a bandwidth management system and method where a temperature is read from a temperature sensor from a master node.

It is a further object of an embodiment of this invention to provide a bandwidth management system and method where changing of the compression parameters is based on a constant network load.

It is a further object of an embodiment of this invention to provide a bandwidth management system and method where the changing of the compression parameters is based on a constant media stream rate above a threshold.

It is a further object of an embodiment of this invention to provide a bandwidth management system and method where the changing of the compression parameters is based on a constant media stream rate above a threshold with intermediate streaming.

It is a further object of an embodiment of this invention to provide a bandwidth management system and method where the compression parameters are controlled in a network without a master node.

It is a further object of an embodiment of this invention to provide video camera system which changes compression rates based on network conditions.

It is a object of an embodiment of this invention to provide a data address controller system which allows users to authenticate and access data streams over an external network.

It is a further object of an embodiment of this invention to provide a data address controller system where the address controller contains a transaction system and/or a subscription system with a database for storing transaction and/or subscription information.

These and other objects of this invention will be readily apparent to those of ordinary skill in the art upon review of the following drawings, detailed description, and claims. In the preferred embodiment of this invention, the system and method makes use of a novel mechanism for detecting the required bandwidth for each data source on a network and dynamically changing the compression scheme/type and the parameters associated with compression such as such as compression ratios, video resolution, video frame rate, audio quality, applying a motion mask and/or motion detection, mass storage and/or buffering, and the like in relation to changing network characteristics. The result is better bandwidth management/data quality without user intervention as network conditions change.

### BRIEF DESCRIPTION OF DRAWINGS

In order to show the manner that the above recited and other advantages and objects of the invention are obtained, a more particular description of the preferred embodiments of this invention, which is illustrated in the appended drawings, is described as follows. The reader should understand that the drawings depict only present preferred and best mode embodiments of the invention, and are not to be considered as limiting in scope. A brief description of the drawings is as follows:

FIG. 1 is a block diagram of the present preferred bandwidth allocation network with a network node and master node.

FIG. 2 is a block diagram of the present preferred bandwidth allocation network with two network nodes and a monitor connected to the master node.

FIG. 3 is a block diagram of the present preferred bandwidth allocation network with two network nodes and a personal computer with a master node.

FIG. 4 is a block diagram of the present preferred bandwidth allocation network with two network nodes which have multiple data sources, and a master node within a Digital Video Recorder (DVR) which communicates over an external network to an address controller and a PC.

FIG. 5 is a block diagram of the present preferred bandwidth allocation network with a Digital Video Recorder with a master node which controls a variety of data sources on a local network.

FIG. 6 is a block diagram of the present preferred bandwidth allocation network with multiple network nodes connected to multiple master nodes which controls various control systems within a network, and communicates over an external network to various devices and system including an address controller and a PC.

FIG. 7 is a flow diagram of the present preferred method of a master node allocating bandwidth with a constant network load.

FIG. 8 is a flow diagram of the present preferred method of a master node allocating bandwidth with a constant media stream rate above threshold.

FIG. 9 is a flow diagram of the present preferred method of allocating bandwidth with a constant media stream rate with no master node for allocating bandwidth.

FIG. 10 is a flow diagram of the present preferred method of a master node allocating bandwidth with a constant network load with possibility for intermittent streaming such as introduced by mass storage and/or motion detection.

FIG. 11 is a flow diagram of the present preferred method of a master node allocating bandwidth with a constant media stream rate above a threshold with the possibility of intermittent streaming such as introduced by mass storage and/or motion detection.

FIG. 12 is a flow diagram of the present preferred method of allocating bandwidth with a constant media stream rate with no master node for allocating bandwidth with the possibility of intermittent streaming such as introduced by mass storage and/or motion detection.

FIG. 13 is a flow diagram of the present preferred method of selecting a master node or control node configuration.

FIG. 14 is a flow diagram of the present preferred method of operating as a network node under control of a master node.

FIG. 15 is a block diagram of the present preferred bandwidth allocation network with two network nodes and a monitor connected to a Digital Video Recorder with an attached monitor.

FIG. 16 is a block diagram of the present preferred bandwidth allocation network with two network nodes and a Digital Video Recorder with a variety of locally attached devices with an external network connection.

FIG. 17 is a block diagram of the present preferred bandwidth allocation network with two network nodes, and a residential gateway which is connected to an address controller and a PC.

FIG. 18 is a flow diagram of the present preferred method of adding, authenticating and providing access to a bandwidth allocation system using an address controller.

Reference will now be made in detail to the present preferred embodiment of the invention, examples of which are illustrated in the accompanying drawings.

### DETAILED DESCRIPTION

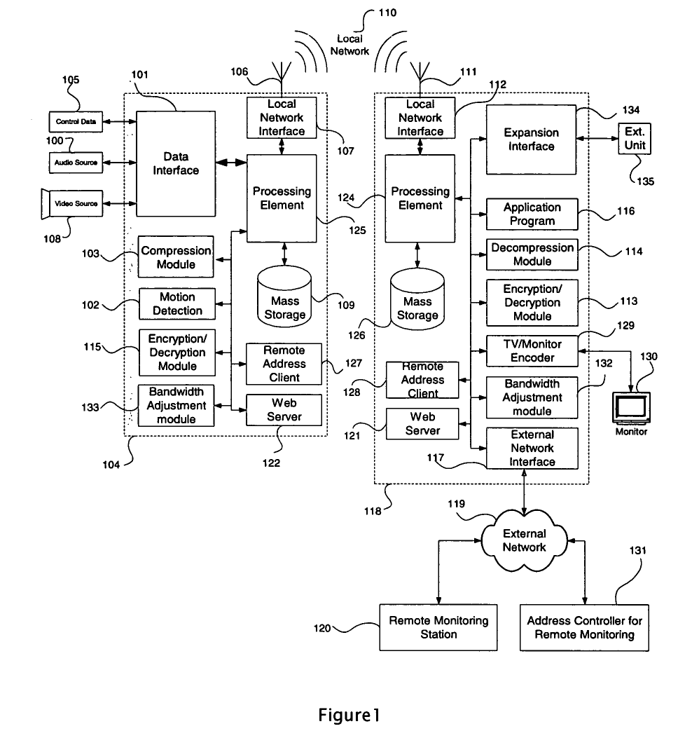

FIG. 1 is a block diagram of the present preferred bandwidth allocation network with a network node 104 and master node 118. Data of various types such as a video source 108 which can be a video camera, digital camera and the like and/or an audio source 100 such as a microphone, MP3 player, and/or a control data 105 and the like is received by the network node 104. The data from the audio source 100 and/or the video source 108 and/or the control data is input into the data interface 101. The data interface 101 can accept data in any of a number of general, standard, and proprietary formats including but not limited to general purpose I/O (GPIO), general purpose parallel, general purpose serial, SPI, I²C, PAL composite, PAL component video, NTSC composite video, NTSC component video, S-video, DVI, various digital camera interfaces, CCIR656, CCIR601, UTI656, UTI601, and the like. The data interface 101 also passes data to the processing element 125 using any one of a variety of electrical and/or register, and/or DMA transfer, and/or semaphore transfer, formats. The processing element 125 performs the function of controlling the modules within the network node 104 including the data interface 101, the compression module 103, the motion detection module 102, the encryption/decryption module 115, the bandwidth adjustment module 133, the web server module 122, and the remote address client module 127, each of which can be hardware or software based functions. The processing element 125 also servers to perform higher level control functions and protocols in communication with devices or elements connected to or networked to the network node 104. The data interface module 101 is controlled by the processing element 125 and is used to select which data source(s) 100, 105, 108 will be processed. Other data sources such as computer data sources can also be fed into the data interface 101. The processing element 125, through the data interface 101, can control the audio source 100 and/or the video source 108 including but not limited to such parameters as brightness, contrast, hue, saturation, luminance decimation filtering, white balance, horizontal interpolative scaling, vertical interpolative scaling, volume control, flow control. In addition, the processing element 125 can insert a time stamp or watermark into the data stream. The processing element 125 controls and formats the data communicated over a local network through the local network interface 107, using but not limited to any one or more protocols such as RTSP, RTP, RTCP, HTTP, ASF, FTP, DDNS, NTP TFTP, TCP/IP, UDP, DHCP, DNS, SMTP, HTML, SNTP, LDAP, SNMP, and the like. For video data received from the data interface 101 and controlled by the processing element 125, the compression module 103 can perform various forms of data compression which directly or effectively reduce the data rates such as the application of standard and/or non-standard algorithms and/or techniques similar in function to MJPEG, MPEG1, MPEG2, MPEG4, MPEG7, MPEG10, H.263, H.264, H.323, Windows Media Video 9 (WMv-9), wavelet compression, and compression with post smoothing techniques, or adjust any of a variety of parameters associated with the said algorithms or techniques, or adjust the video resolution of each video stream, or adjust the frame rate of each video stream, based on network bandwidth controlled through the bandwidth adjustment module 133. In addition, the compression module 103 can be used to perform other effective compression techniques (reduction in data) such as change color content or color space parameters. For audio sources 100, the compression module 103 can change the quality of the signal from the audio source 100 based on network bandwidth, compression rates, user input and the like. The data received from compression module 103 is processed by the processing element 125. Video sources 108, controlled and processed by the processing element 125, are processed by any of several motion detection algorithms and/or techniques utilized by the motion detection module 102 to determine motion between frames and/or groups of frames. Motion detected by the motion detection module 102 can be compared to a motion mask such that certain predetermined changes can be ignored. The motion mask can be applied wherein the mask parameters can use one or more of the follow methods, user determined, automatically learned, defined as geometric shapes, defined as non-geometric shapes, defined by region, defined by object size, defined by object speed, defined by object micro movements, and defined by object macro, or the like. The motion detector 102 detects changes in the current video image and sends video data to be stored in mass storage 109 or mass storage 126 over the local network, or for viewing over the network, or for viewing over the external network, when motion has been detected. The sent video data can include a certain amount of data prior to or after the detected motion instead of the continuous video stream thereby reducing the amount of data sent from the video source 108. A compression technique is selected by the compression module 103. Data from both the video source 108 and/or the audio source 100 are compressed using the selected compression algorithm and/or combined techniques. The compression algorithm and/or combined techniques can be dynamically selected based on system needs. Different audio/video compression algorithms and/or techniques can be selected based on bandwidth requirements, user input, and the like. The data can be encrypted using the encryption/decryption module 115. The encryption/decryption module 115 can support various types of encryption such as DES, Triple DES, RSA, PK1, RC4, RC5, AES, 128 bit, 64 bit, 56 bit, and the like. Different types of encryption or no encryption can be selected dynamically in the encryption/decryption module 115 if the system requires. The bandwidth adjustment module 133 is used to communicate over the network and allocate bandwidth based on network conditions such as, but not limited to RF interference, changing network impedance, impedance mismatches, RF harmonics, multipath effects, various channel fading effects, network traffic volume, conducted noise, induced noise, self induced noise, friendly noise, intermodulation products, and the like for the data streams from the video source 108, the audio source 100, and the control data 105. If network and/or system conditions are such that it is not required or optimal to send data or based on other conditions including user options, the data can be temporarily stored in mass storage 109. The types of encryption, compression, resolution, audio quality, data sources, and the like can be administered by input from the web server 122 or from the remote monitoring station 120. The data streams 100, 105, 108, can be networked to an address controller 131 which communicates with the remote address client 127. The communication between the remote address client 127 and the address controller 131 constitute a service which administers IP addressing and other administrative information allowing users to securely access their data streams 100, 105, 108 remotely. The compressed and/or encrypted data from the video source 108 and/or audio source 100 is sent on a local network interface 107 and an antenna 106, coupling device, over a wireless or wireless-like local network 110. The master node 118 can be wholly or partially incorporated into a PC, a set top box, a residential gateway, a digital video recorder (DVR), a person video recorder, a video server, a living room PC, a networking device, or stand alone. The local network interface 107, in conjunction with the processing element 125 and the bandwidth adjustment module 133 can sense network conditions on the local network 110. The type of local network 110 can be, but is not limited to a wireless network, a power line network, a wired network, an optic network, an acoustic network, and the like. Generally, a power line network is a network over the AC power lines in a building, facility, home and the like. The data is received on a master node 118 at the antenna 111 or coupling device and the local network interface 112. The local network interface 112 in conjunction with the processing element 124 and bandwidth adjustment module 132, within the master node 118 can sense network conditions on the local network 110. The processing element 124 performs the function of controlling and/or encompassing the modules within the master node 118 including the decompression module 114, the encryption/decryption module 113, the bandwidth adjustment module 132, the web server module 121, the remote address client module 128, the application program 116, the TV/monitor encoder 129, and the external network interface 117 each of which can be hardware or software based functions. The processing element 124 also servers to perform higher level control functions and protocols in communication with devices or elements connected to or networked to the master node 118. The processing element 124 controls and formats and receives data communicated over the local network similar and complimentary to the network node processing element 125. Stream video and/or audio stream data received by the processing element 124 is decompressed using the decompression module 114 and algorithms and/or techniques similar to the compression module 103. Transmitted/Received data processed through the process element can be encrypted/decrypted using the encryption/decryption module 113. The bandwidth adjustment module 132 communicates over the local network to determine the needs of each of the data streams 105, 100, 108 and the data streams of other network nodes and how much bandwidth is available to each network node 104 to determine the proper compression parameters such as ratios, frame rates, compression types, and the like. The TV/Monitor encoder 129 can accept data from a video stream 108 and/or the mass storage 109, 126 and display the information on the monitor 130 under control of the processing element 124 and/or under the control of the application program 116. The application program 116 can perform as a digital video recorder (DVR) receiving or routing video data streams from any network node and/or to/from mass storage in conjunction the processing element 124 and other master node modules such as the decompression module 114, the TV/monitor encoder 129, and also receiving flags from the motion detection module 102. The processing element 124 can send the data to the application program 116 and/or can send the data to mass storage 126. The application program 116 in conjunction with the web server 121 and remote address client 128, sends the data to the external network interface 117, which sends the data over an external network 119 to a remote monitoring station 120. The external network 119 can be, but is not limited to, the Internet, a Wide Area Network (WAN), a Local Area Network (LAN) and the like. The master node 118 can be administered by the web server 121 and/or the remote monitoring station 120. Access to the data sources 105, 100, 108, along with mass storage data can be accessed by the remote monitoring station in conjunction with the address controller 131 and the remote access client 128. The address controller 131 is a service that allows users of the system to access and view the data streams 100, 105, 108, or mass storage 109, 126, data over the external network 119 by communicating to the address controller 131. The processing element 124 can communicate with and/or control and/or exchange data with an external unit 135 such as, but limited to, a set top box, an external DVR, and external processor, an external video processor, and the like. The processing element 124 can communicate with an expansion interface 134 which is connected to an expansion unit 135. This allows other devices to be connected to the master node 118.

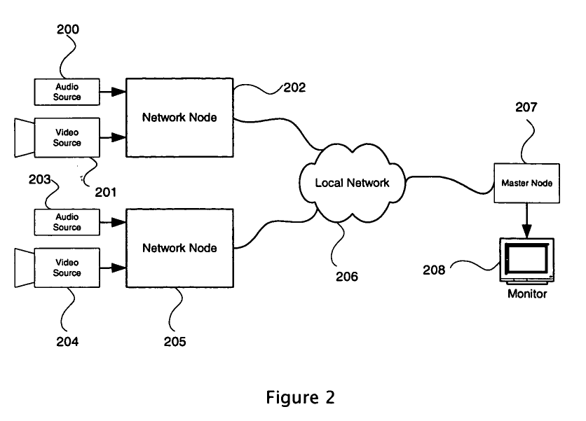

FIG. 2 is a block diagram of the present preferred bandwidth allocation network with two network nodes 202, 205 and a monitor 208 connected to the master node 207. Data from an audio source 200 and a video source 201 are connected to a network node 202 which is connected to a local network 206. Data from a second audio source 203 and a second video source 204 are connected to a second network node 205 which is connected to the local network 206. Both network nodes 202, 205 communicate over the local network 206 to a master node 207. The master node 207 can also perform the same function as a network node 202, 205. The master node 207 controls how much bandwidth is allocated, the types of compression, the compression parameters, and the data rate reduction parameters, for all the data sources 200, 201, 203, 204 based on the available bandwidth of the local network 206, system settings, and user settings. The difference between a master node 207 and a network node 202, 205 is that the master node 207 can control bandwidth for all data sources on the local network 206, where the network node 202, 205 can only control bandwidth for the data sources 200, 201, 203, 204, connected to the network node 202, 205. The data from the video and audio sources 200, 201, 203, 204 are displayed/listened to on the monitor 208. Although shown in this figure, with two network nodes, the concept of this invention is not limited thereto.

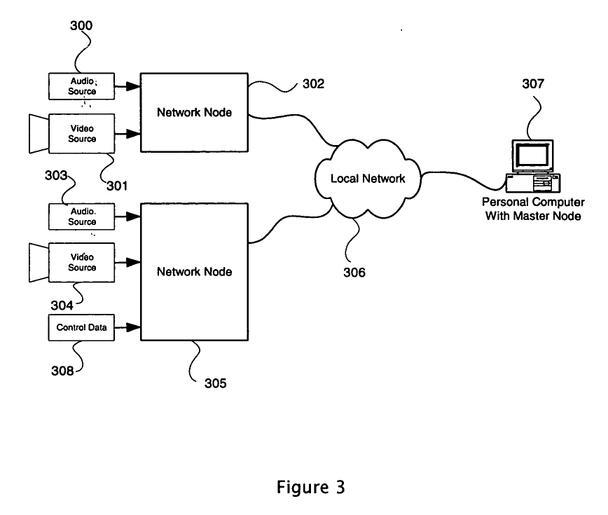

FIG. 3 is a block diagram of the present preferred bandwidth allocation network with two network nodes 302, 305 and a personal computer with a master node 307. Data from an audio source 300 and a video source 301 are connected to a network node 302 which is connected to a local network 306. Data from a second audio source 303, a second video source 304, and control data 308 are connected to a second network node 305 which is connected to the local network 306. Both network nodes 302, 305, communicate over the local network 306 to a master node inside of a personal computer 307. The master node inside the personal computer 307 can also perform the same function as a network node 302, 305. The master node in the personal computer 307 controls how much bandwidth is allocated, the types of compression, and the compression parameters, and the data rate reduction parameters, for all the data sources 300, 301, 303, 304, 308, based on the available bandwidth of the local network 306, system settings, and user settings. The data from the video and audio sources 300, 301, 303, 304, 308, can be displayed on the personal computer 307.

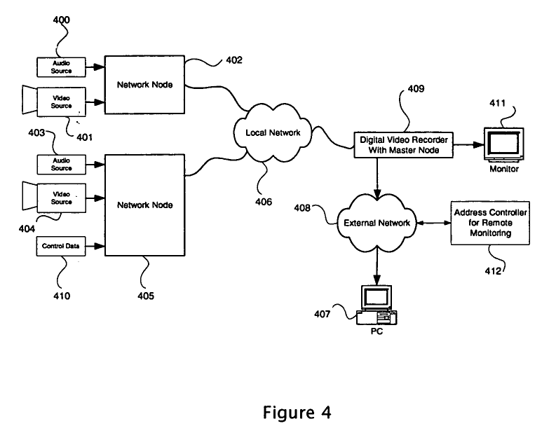

FIG. 4 is a block diagram of the present preferred bandwidth allocation network with two network nodes 402, 405 which have multiple data sources 400, 401, 403, 404, 410, and a master node within a Digital Video Recorder (DVR) 409 which communicates over an external network 408 to an address controller 412 and a PC 407 as well as to a monitor 411. Data from an audio source 400 and a video source 401 are connected to a network node 402 which is connected to a local network 406. Data from a second audio source 403, a second video source 404 and a data source 410 are connected to a second network node 405 which is connected to the local network 406. Both network nodes 402, 405 communicate over the local network 406 to a master node within a Digital Video Recorder (DVR) 409. The master node in the DVR 409 can also perform the same function as a network node 402, 405. The master node in the DVR 409 controls how much bandwidth is allocated, the types of compression, the compression rates, compression parameters, and the data rate reduction parameters, for all the data sources 400, 401, 403, 404, 410 based on the available bandwidth of the local network 406, system settings, and user settings. The data from the video, audio, and data sources 400, 401, 403, 404, 410 can be sent from the master node within the DVR 409 over the external network 408 to a personal computer 407 for viewing or storage. The data from the video, audio, and data sources 400, 401, 403, 404, 410 can also be sent to the monitor 411 in communication with the master node 409. The digital video recorder 409 is preferably connected to a medium for storage of data from the data source 410, the audio sources 400, 403, and the video sources 404, 401. The Address controller 412 is a service or process which allows users access to the data streams 400, 401, 403, 404, 410 over the external network 408.

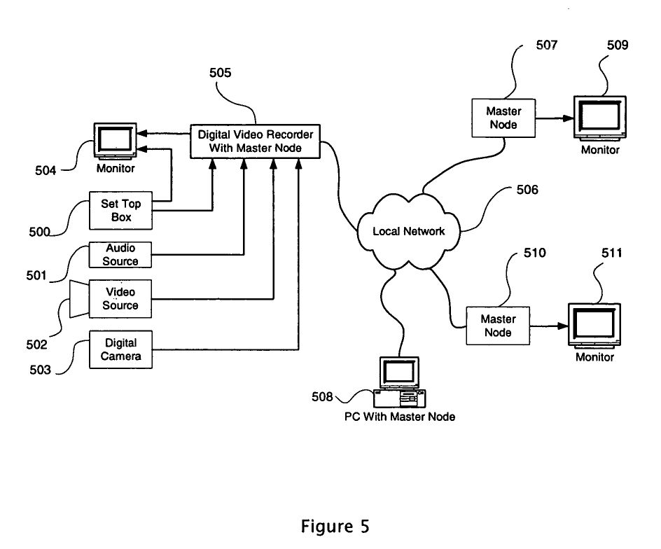

FIG. 5 is a block diagram of the present preferred bandwidth allocation network with a Digital Video Recorder 505 with a master node which controls a variety of data sources 500, 501, 502, 503 on a local network 506. Data from a variety of sources 500, 501, 502, 503 is connected to a Digital Video Recorder with a master node 505, which can be included a set top box located with a master node or a game box located with a master node or a living room personal computer with a master node so long as a DVR capability is present. The possible data sources include a set top box 500, an audio source 501, a video source 502, and a digital camera 503. The data from the data sources 500, 501, 502, 503, can be sent over the local network 506 to any master node 505, 507, 508, 510. The data from the data sources 500, 501, 502, 503, can be displayed on the monitors 504, 509, 511, 508.

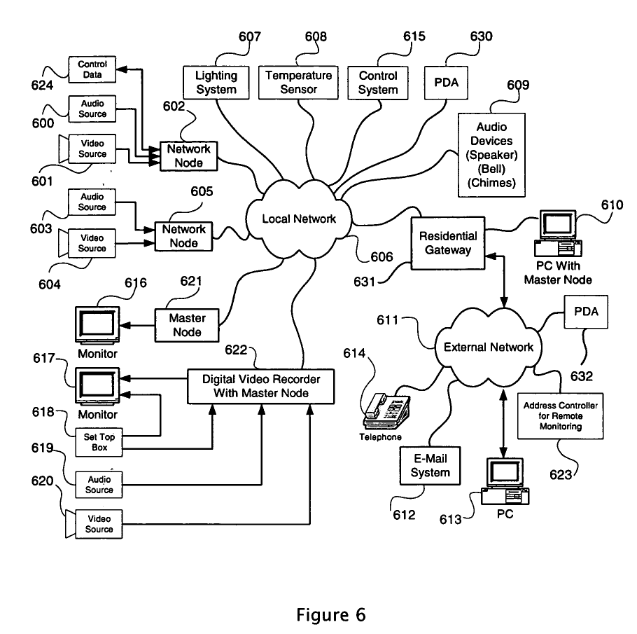

FIG. 6 is a block diagram of the present preferred bandwidth allocation network with multiple network 602, 605 nodes connected to multiple master nodes 621, 622, 610, which controls various control systems within a network, and communicates over an external network 611 to various devices and systems including an address controller and a PC.

Data from an audio source 600, a video source 601, and control data 624 are connected to a network node 602 which is connected to a local network 606. Data from a second audio source 603 and a second video source 604 are connected to a second network node 605 which is connected to the local network 606. Both network nodes 602, 605 communicate over the local network 606 to a residential gateway with a master node 631. The residential gateway with the master node 631 controls how much bandwidth is allocated, the types of compression, the compression rates, the compression parameters, and the data rate reduction parameters, for all the data sources 600, 601, 603, 604, 624, based on the available bandwidth of the local network 606, system settings, and user settings. Data from a second master node 621 which has an attached monitor 616 can be used to monitor the data from the data streams 600, 601, 603, 604, 624. A Digital Video Recorder with a master node 622 also has an attached monitor 617. The Digital Video Recorder with a master node 622 receives input from a set top box 618, an audio source 619, and a video source 620. The residential gateway with a master node 631 controls the flow of data from the data sources 600, 601, 603, 604, 624, 618, 619, 620, connected to each network node 602, 605, 622, 621, to the personal computer 613 or Personal Digital Assistant 632 which is connected to the residential gateway with a master node 631 over an external network 611. Administration of network nodes and receipt of the data streams 600, 601, 603, 604, 624, 618, 619, 620, can also be received on the locally attached personal computer 610 or on the locally attached Personal Digital Assistant (PDA) 630. The external network 611 can be, but is not limited to the Internet, a Wide Area Network (WAN), a Local Area Network (LAN) and the like. The residential gateway with a master node 631 is also responsible for controlling other control systems which are attached to the local power line network 606. Control systems such as lighting systems 607, temperature sensors 608, audible devices 609 such as speakers, bells, chimes and the like are connected to the local network 606. The local network 606 may be a power line network. The residential gateway with a master node 631 can detect changes from a video source 601, 604, 620 and/or an audio source 600, 603, 619, and turn on an audio device 609 and/or a lighting system 607 with an audio control signal or a lighting control signal. Input from a temperature sensor 608 can be used to detect and/or change the view of a video source 601, 604, in order to observe fire, water damage, or other conditions. When the residential gateway with a master node 631 detects changes in data from a video source 601, 604, an e-mail, can be sent over the external network 611 to an e-mail system 612 and/or e-mail recipient. The e-mail can also be sent over the local network 606 to an e-mail system attached to the local network 606. Voice messages, text messages, can be sent from the residential gateway with a master node 631 over the external network 611 to a telephone/cell phone 614 based on conditions that occur on devices 600, 601, 602, 603, 604, 605, 607, 608, 609, 610, 630, 631, 618, 619, 620, on local network 606. Alerts or other information can also be sent from the residential gateway with a master node 631 over the external network 611 to the personal computer 613. An address controller 623 is used to coordinate addressing in so that users can view/listen to the data streams/audio streams from the data sources 600, 601, 603, 604, 624, 618, 619, 620, over the external network 611.

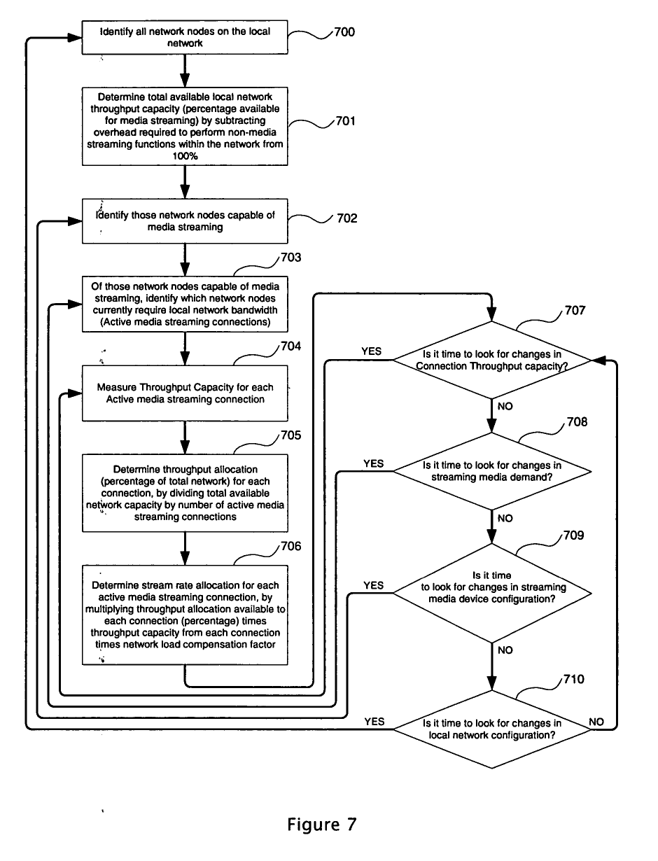

FIG. 7 is a flow diagram of the present preferred method of a master node allocating bandwidth with a constant network load. The process begins when the identity of the network nodes are determined 700 on the local network. The total available local network throughput capacity is determined 701 typically, though not exclusively by subtracting the overhead required to perform non-media streaming functions within the network from 100%. The network nodes capable of media streaming are identified 702. Of those network nodes capable of media streaming, the network nodes which currently require local network bandwidth are identified 703. Throughput capacity is measured 704 for each active media streaming connection. The throughput allocation (percentage of total network bandwidth) is determined 705 for each connection typically, though not exclusively by dividing total available network capacity by the number of active media streaming connections. The stream rate allocation is determined 706 for each active media streaming connection typically, though not exclusively by multiplying throughput allocation available to each connection (percentage) times throughput capacity from each connection times the network load compensation factor. The compensation factor is used to account for changes in available bandwidth within the network. The process checks 707 to see if it is time to look for changes in the connection throughput capacity. If it is time to check 707 for changes in the connection throughput capacity, the process measures 704 the throughput capacity for each active media streaming connection. Otherwise, if test 707 is no, the process checks 708 to see if it is time to look for changes in streaming media demand. If it is time to check 708 for changes in streaming media demand, the process identifies 703 the network nodes capable of media streaming which require local network bandwidth. Otherwise, if test 708 is no, the process checks 709 to see if it is time to look for changes in streaming media device configuration. If it is time to look for changes, the process identifies 702 those networks nodes capable of media streaming. If test 709 is no, the process checks 710 to see if it is time to look for changes in the local network configuration. If changes in the local network configuration need to be made in test 710, the process identifies 700 all network nodes on the local network. Otherwise, if it is not time to look for changes in the local network configuration in test 710, the process checks 707 to see if it is time to look for changes in connection throughput capacity. In alternative embodiments the calculations used in the various process determinations may be varied without departing from the concept of this invention. Although these steps are preformed in the designated order in the present embodiments, in alternative envisioned embodiments of this invention, the ordering of the steps can be varied significantly without departing from the concept of this invention.

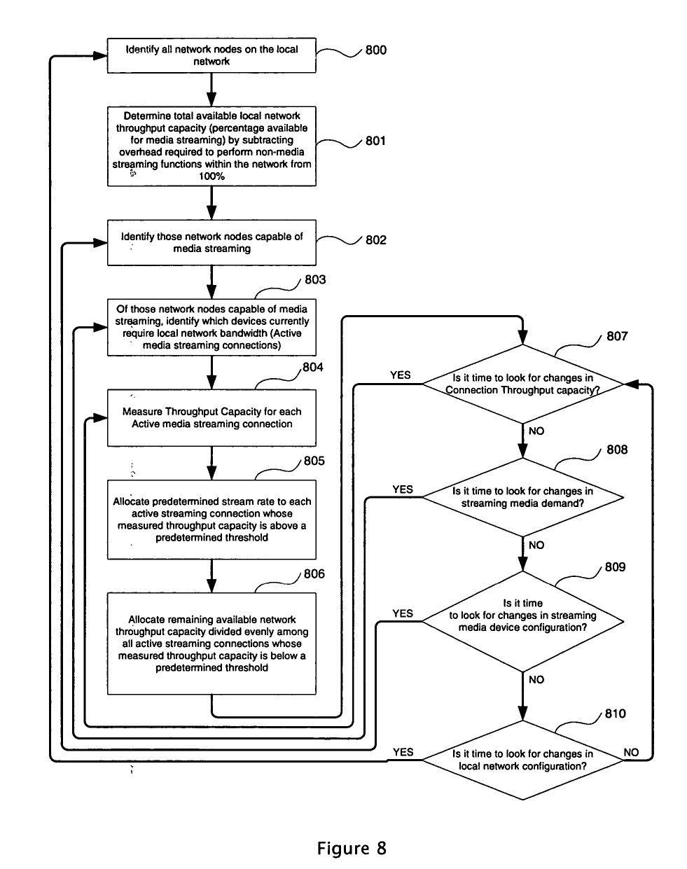

FIG. 8 is a flow diagram of the present preferred method of a master node allocating bandwidth with a constant media stream rate above a threshold. The process begins when the identity of the network nodes are determined 800 on the local network. The total available local network throughput capacity is determined 801 typically, but not exclusively by subtracting the overhead required to perform non-media streaming functions within the network from 100%. The network nodes capable of media streaming are identified 802. Of those network nodes capable of media streaming, the network nodes which currently require local network bandwidth are identified 803. Throughput capacity is measured 804 for each active media streaming connection. The process allocates 805 a predetermined stream rate to each active streaming connection whose measured throughput capacity is above a predetermined threshold. The process presently allocates 806 the remaining available network throughput capacity evenly among all active streaming connections whose measured throughput capacity is below a predetermined threshold. In alternative embodiments, the allocation network capacity need not be evenly divided among connections. The process checks 807 to see if it is time to look for changes in the connection throughput capacity. If it is time to check 807 for changes in the connection throughput capacity, the process measures 804 the throughput capacity for each active media streaming connection. Otherwise, if test 807 is no, the process checks 808 to see if it is time to look for changes in streaming media demand. If it is time to check 808 for changes in streaming media demand, the process identifies 803 the network nodes capable of media streaming which require local network bandwidth. Otherwise, if test 808 is no, the process checks 809 to see if it is time to look for changes in streaming media device configuration. If it is time to look for changes in the streaming media device configuration, the process identifies 802 those networks nodes capable of media streaming. Otherwise, if test 809 is no, the process checks 810 to see if it is time to look for changes in the local network configuration. If changes in the local network configuration need to be made in test 810, the process identifies 800 all network nodes on the local network. Otherwise, if it is not time to look for changes in the local network configuration in test 810, the process checks 807 to see if it is time to look for changes in connection throughput capacity. In alternative embodiments the calculations used in the various process determinations may be varied without departing from the concept of this invention. Although these steps are preformed in the designated order in the present embodiments, in alternative envisioned embodiments of this invention, the ordering of the steps can be varied significantly without departing from the concept of this invention.

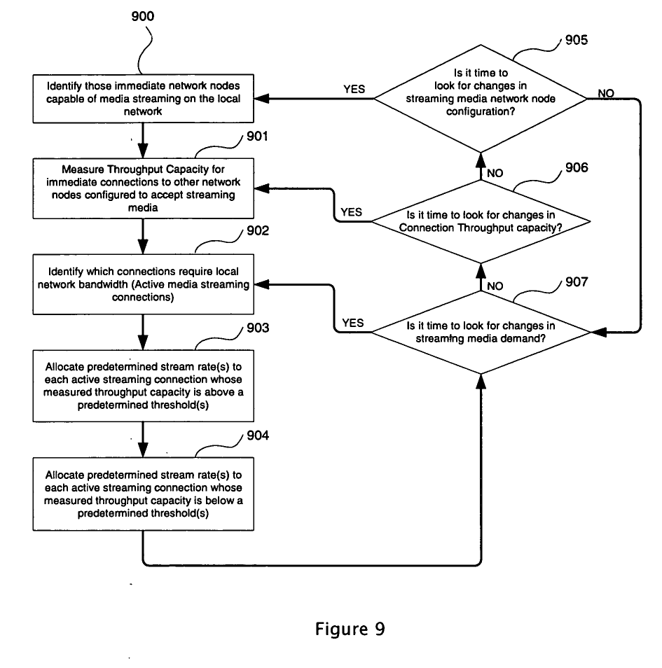

FIG. 9 is a flow diagram of the present preferred method of allocating bandwidth with a constant media stream rate with no master node for allocating bandwidth. The process begins when the network nodes are identified 900 which are capable of media streaming on the local network. The throughput capacity is measured 901 for immediate connections to other network nodes configured to accept streaming media. The process identifies 902 which streaming connections require local network bandwidth. The predetermined stream rate(s) are allocated 903 to each streaming connection whose measured throughput capacity is above a predetermined threshold or thresholds. The predetermined stream rate(s) are allocated 904 to each active streaming connection whose measured throughput capacity is below a predetermined threshold or thresholds. The process checks 907 to see if it is time to look for changes in the demand for streaming media. If it is time to look for changes in the demand for streaming media in test 907, the process identifies 902 which active streaming media connections require local network bandwidth. Otherwise, if test 907 is no, the process checks 906 to see if it is time to look for changes in connection throughput capacity. If it is time to look for changes in connection throughput capacity in test 906, the process measures 901 the throughput capacity for immediate connection to other network nodes configured to accept streaming media. Otherwise, if test 906 is no, the process checks 905 to see if it is time to look for changes in the streaming media network node configuration. If it is time to look for changes in the streaming media network node configuration in test 905, the process identifies 900 those immediate network nodes capable of media steaming on the local network. Otherwise, if test 905 is no, the process checks 907 to see if it is time to look for changes in streaming media demand. In alternative embodiments the calculations used in the various process determinations may be varied without departing from the concept of this invention. Although these steps are preformed in the designated order in the present embodiments, in alternative envisioned embodiments of this invention, the ordering of the steps can be varied significantly without departing from the concept of this invention.

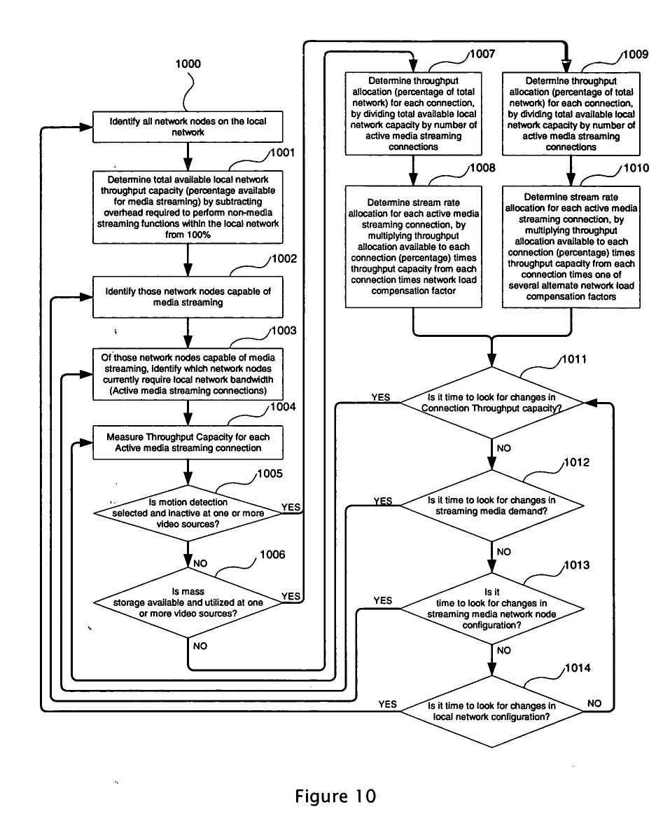

FIG. 10 is a flow diagram of the present preferred method of a master node allocating bandwidth with a constant network load with possibility for intermittent streaming such as introduced by mass storage and/or motion detection. The process begins by identifying 1000 all network nodes on the local network. The total available local network throughput (the percentage available for media streaming) is determined 1001 presently, but not exclusively by subtracting the overhead required to perform non-media streaming functions within the local network from 100%. The network nodes capable of media streaming are identified 1002. Of the network nodes capable of media streaming the process identifies 1003 which network nodes currently require local network bandwidth for active media streaming connections. The process measures 1004 throughput capacity for each active media streaming connection. The process checks 1005 to see if motion detection is selected and inactive at one or more video sources. This check 1005 is to see if the video stream has to be a constant stream. The present preferred embodiment checks for video sources, but can also check for audio or data sources and the like to see if the sources can handle non-constant rates. If motion detection is selected and inactive at one or more video sources in test 1005, the process determines 1009 the throughput allocation for each connection in the current embodiment by dividing total available local network capacity by the number of active media streaming connections. The process determines 1010 the stream rate allocation for each active media streaming connection in the current embodiment by multiplying the throughput allocation available to each connection times the throughput capacity from each connection times one of several alternate network load compensation factors. Otherwise, if test 1005 is no, the process checks 1006 to see if mass storage is available and utilized at one or more video sources. If mass storage is available and utilized at one or more video sources in test 1006, the process determines 1009 the throughput allocation for each connection in the current embodiment by dividing total available local network capacity by the number of active media streaming connections. The process determines 1010 the stream rate allocation for each active media streaming connection in the current embodiment by multiplying the throughput allocation available to each connection times the throughput capacity from each connection times one of several alternate network load compensation factors. Otherwise, if test 1006 is no, the process determines 1007 the throughput allocation for each connection in the current embodiment by dividing total available local network capacity by the number of active media streaming connections. The process determines 1008 the stream rate allocation for each active media streaming connection in the current embodiment by multiplying the throughput allocation available to each connection times the throughput capacity from each connection times the network load compensation factor. Test 1011 checks to see if it is time to look for changes in connection throughput capacity. If changes in the throughput capacity are required in test 1011, the process measures 1004 through put capacity for each active media streaming connection. Otherwise, if test 1011 is no, the process checks 1012 to see if it is time to look for changes in the streaming media demand. If there are changes in the streaming media demand in test 1012, the process determines 1003 which of the network nodes currently require local network bandwidth. Otherwise, if test 1012 is no, the process checks 1013 to see if it is time to look for changes in streaming media network node configuration. If there are changes in the streaming media network node configuration in test 1013, the process identifies 1002 those network nodes capable of media streaming. Otherwise, if test 1013 is no, the process checks 1014 to see if it is time to look for changes in the local network configuration. If there are changes in the local network configuration in test 1014, the process identifies 1000 all the network nodes on the local network. Otherwise, if test 1014 is no, the process checks 1011 to see if it is time to look for changes in the connection throughput capacity. In alternative embodiments the calculations used in the various process determinations may be varied without departing from the concept of this invention. Although these steps are preformed in the designated order in the present embodiments, in alternative envisioned embodiments of this invention, the ordering of the steps can be varied significantly without departing from the concept of this invention.

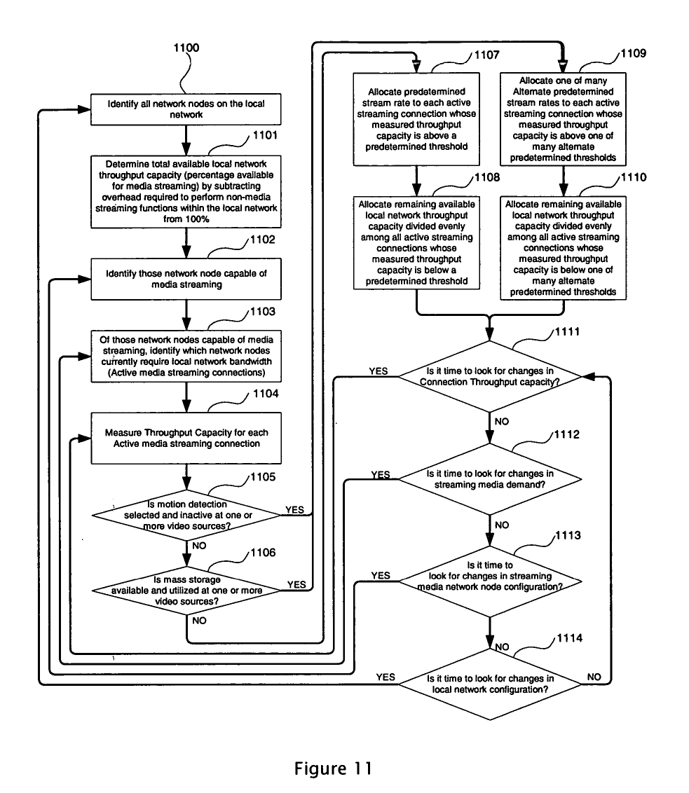

FIG. 11 is a flow diagram of the present preferred method of a master node allocating bandwidth with a constant media stream rate above a threshold with the possibility of intermittent streaming as introduced by mass storage and/or motion detection. The process begins by identifying 1100 all network nodes on the local network. The total available local network throughput (the percentage available for media streaming) capacity is determined 1101 in the current embodiment by subtracting the overhead required to perform non-media streaming functions within the local network from 100%. The network nodes capable of media streaming are identified 1102. Of the network nodes capable of media streaming the process identifies 1103 which network nodes currently require local network bandwidth for active media streaming connections. The process measures 1104 throughput capacity for each active media streaming connection. The process checks 1105 to see if motion detection is selected and inactive at one or more video sources. This check 1105 is to see if the video stream has to be a constant stream. The present preferred embodiment checks for video sources, but can also check for audio or data sources and the like to see if the sources can handle non-constant rates. If motion detection is selected and inactive at one or more video sources in test 1105, the process allocates 1109 one of many alternate predetermined stream rates to each active streaming connection whose measured throughput capacity is above one of many alternate predetermined thresholds. The process allocates 1110 the remaining available local network throughput capacity divided approximately evenly in this embodiment among all active streaming connections whose measured throughput capacity is below one of many alternate predetermined thresholds. Otherwise, if test 1105 is no, the process checks 1106 to see if mass storage is available and utilized at one or more video sources. If mass storage is available and utilized at one or more video sources in test 1106, the process allocates 1109 one of many alternate predetermined stream rates to each active streaming connection whose measured throughput capacity is above one of many alternate predetermined thresholds. The process allocates 1110 the remaining available network throughput capacity divided among all active streaming connections whose measured throughput capacity is below one of many alternate predetermined thresholds. If test 1106 is no, the process allocates 1107 the predetermined stream rate to each active streaming connection whose measured throughput capacity is above a predetermined threshold. The process allocates 1108 the remaining available local network throughput capacity divided among all active streaming connections whose measured throughput capacity is below a predetermined threshold. Test 1111 checks to see if it is time to look for changes in connection throughput capacity. If changes in the throughput capacity are required in test 1111, the process measures 1104 throughput capacity for each active media streaming connection. Otherwise, if test 1111 is no, the process checks 1112 to see if it is time to look for changes in the streaming media demand. If there are changes in the streaming media demand in test 1112, the process determines 1103 which of the network nodes are capable of media streaming and which currently require local network bandwidth. Otherwise, if test 1112 is no, the process checks 1113 to see if it is time to look for changes in streaming media network node configuration. If there are changes in the streaming media network node configuration in test 1113, the process identifies 1102 those network nodes capable of media streaming. Otherwise, if test 1113 is no, the process checks 1114 to see if it is time to look for changes in the local network configuration. If there are changes in the local network configuration in test 1114, the process identifies 1100 all the network nodes on the local network. Otherwise, if test 1114 is no, the process checks 1111 to see if it is time to look for changes in the connection throughput capacity. In alternative embodiments the calculations used in the various process determinations may be varied without departing from the concept of this invention. Although these steps are preformed in the designated order in the present embodiments, in alternative envisioned embodiments of this invention, the ordering of the steps can be varied significantly without departing from the concept of this invention.

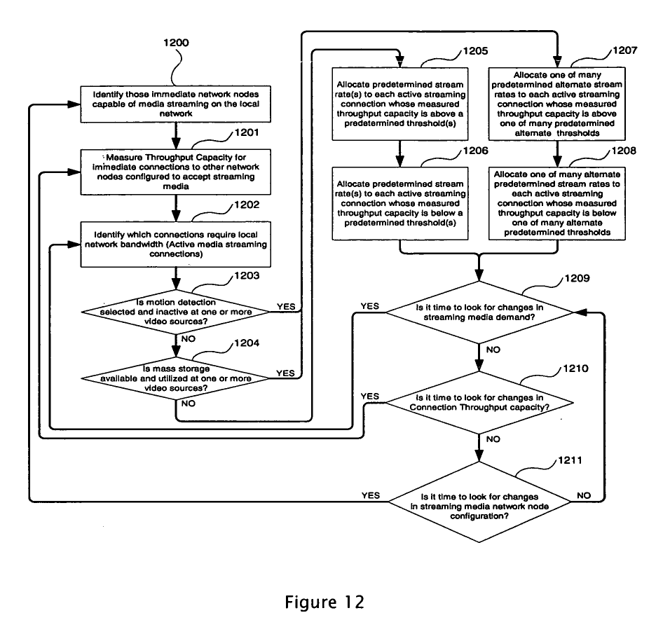

FIG. 12 is a flow diagram of the present preferred method of allocating bandwidth with a constant media stream rate with no master node for allocating bandwidth with the possibility of intermittent streaming as introduced by mass storage and/or motion detection. The process begins by identifying 1200 those network nodes capable of media streaming on the local network. Throughput capacity is measured 1201 for immediate connections to other network nodes configured to accept streaming media. The connections which require local network bandwidth are identified 1202. Test 1203 determines if motion detection is selected and inactive at one or more video sources. If motion detection is selected and inactive at one or more video sources in test 1203, the process allocates 1207, one of many predetermined alternate stream rates to each active streaming connection who measured throughput capacity is above one of many predetermined alternate thresholds. The process allocates 1208 one of many alternate predetermined stream rates to each active streaming connection whose measured throughput capacity is below one of many alternate predetermined thresholds. Otherwise, if test 1203 is no, the process checks 1204 to see if mass storage is available and utilized at one or more video sources. If mass storage is available and utilized at one or more video sources in test 1204, the process allocates 1207, one of many predetermined alternate stream rates to each active streaming connection who measured throughput capacity is above one of many predetermined alternate thresholds. The process allocates 1208 one of many alternate predetermined stream rates to each active streaming connection whose measured throughput capacity is below one of many alternate predetermined thresholds. Otherwise, if test 1204 is no, the process allocates 1205 predetermined stream rate(s) to each active streaming connection whose measured throughput capacity is above a predetermined threshold(s). The process allocates 1206 predetermined stream rate(s) to each active streaming connection whose measured throughput capacity is below a predetermined threshold(s). The process checks 1209 to see if it is time to look for changes in the streaming media demand. If there is a change in the streaming video demand in test 1209, the process identifies 1202 which connections require local network bandwidth. If test 1209 is no, the process checks 1210 to see if it is time to look for changes in connection throughput capacity. If there are changes in throughput capacity in test 1210 the process measures 1201 the throughput capacity for immediate connection to other network nodes configured to accept streaming media. Otherwise if test 1210 is no, the process checks 1211 to see if it is time to look for changes in streaming media network node configuration. If there are changes in the streaming media network node configuration in test 1211, the process identifies 1200 those immediate network nodes capable of media streaming on the local network. Otherwise, if test 1211 is no, the process checks 1209 to see if it is time to look for changes in streaming media demand. In alternative embodiments the calculations used in the various process determinations may be varied without departing from the concept of this invention. Although these steps are preformed in the designated order in the present embodiments, in alternative envisioned embodiments of this invention, the ordering of the steps can be varied significantly without departing from the concept of this invention.

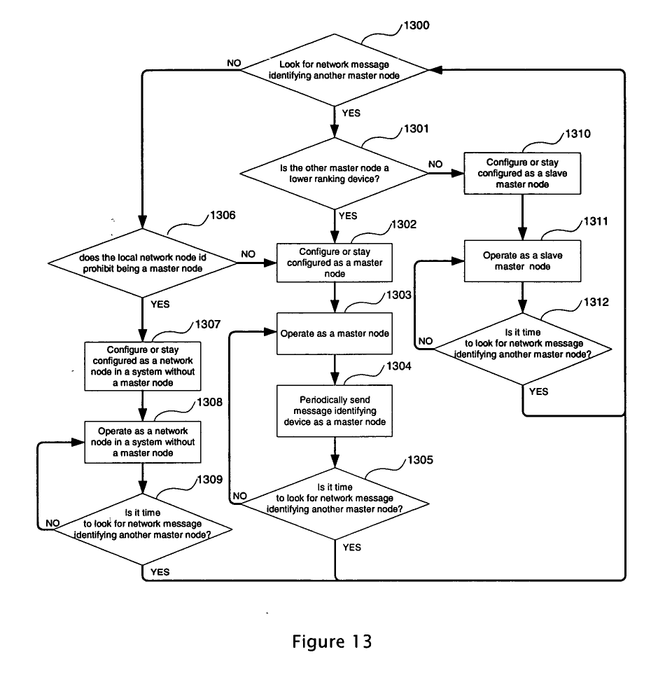

FIG. 13 is a flow diagram of the present preferred method of selecting a master node or control node configuration. The process begins when a network node which is capable of being a master node looks 1300 for a network message identifying another master node. If there is a message from another master node in test 1300, the process checks 1301 to see if the other master node is a lower ranking device. If the other master device is a lower ranking device in test 1301, the master node configures 1302 or stays configured as a master node. The master node operates 1303 as a master node. The master node periodically sends 1304 a message identifying the master node as a master node. The master node checks 1305 to see if it is time to look for a network message identifying another master node. If a network message is not identified in test 1305, the process operates 1303 as a master node. Otherwise, if test 1305 is yes, the process looks 1300 for a network message identifying another master node. If there is no network message from another master node in test 1300, the process checks 1306 to see if the local device identifier prohibits the node from being a master node. If no, the network node configures 1302 or stays configured as a master node. If test 1306 is yes, the network node configures 1307 itself to operate as a network node in a system without a master node. The network nodes 1308 operate as a network node in a system without a master node. The network node checks 1309 to see if it is time to look for a network message identifying a master node. If it is not time to look for a network message identifying a master node in test 1309, the network node operates 1308 as a network node in a system without a master node. Otherwise, if test 1309 is yes, the network node looks 1300 for a network message identifying a master node. If there is not another master node that is lower ranking in test 1301, the master node configures 1310 itself as a slave master node. The slave master node operates 1311 as a slave master node. The slave master node checks 1312 to see if it is time to look for a network message identifying another master node. If it is not time to look for a network message identifying another master node in test 1312, the slave master node continues to operate 1311 as a slave master node. Otherwise, if test 1312 is yes, the process looks 1300 for a network message identifying another master node. Although these steps are preformed in the designated order in the present embodiments, in alternative envisioned embodiments of this invention, the ordering of the steps can be varied significantly without departing from the concept of this invention.

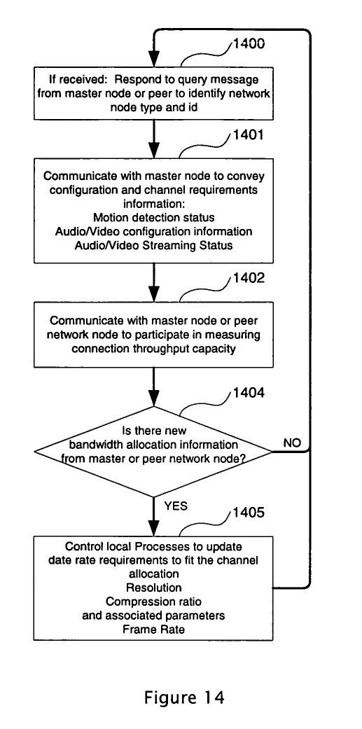

FIG. 14 is a flow diagram of the present preferred method of operating as a network node under control of a master node. The process begins when the network node receives a query message from the master control node or peer node if there is no master node in the network. If so, the network node responds 1400 to the master node or peer and identifies the slave master node's device type and identifier. The network node or slave master node communicates 1401 with the master node or peer to convey the configuration and channel requirement information. This includes, but is not limited to motion detection status, audio/video configuration information, audio/video streaming status, and the like. The network node communicates 1402 with the master node or peer node to participate in measuring connection throughput capacity. The network node 1404 checks to see if there is new bandwidth allocation information from the master node or peer node. If there is new information from the master node or peer node in test 1404, the local process is controlled 1405 to update data rate requirements to fit such information as some or all of the following: channel allocation, resolution, compression ratio, associated parameters, frame rate, and the like. The network node checks 1400 if a query message was received from a master node or peer note and responds if a message was received with the network node's device type and identifier. Otherwise, if test 1404 is no, the network node checks 1400 if a query message was received from a master node or peer note and responds if a message was received with the network node's device type and identifier. In alternative embodiments the calculations used in the various process determinations may be varied without departing from the concept of this invention. Although these steps are preformed in the designated order in the present embodiments, in alternative envisioned embodiments of this invention, the ordering of the steps can be varied significantly without departing from the concept of this invention.

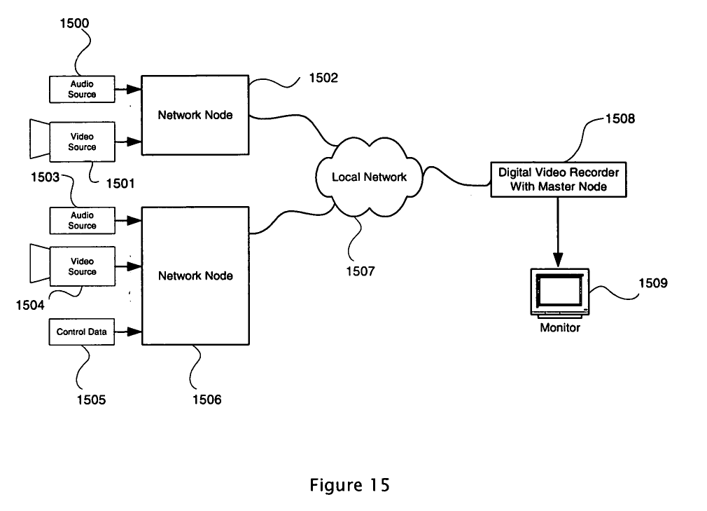

FIG. 15 is a block diagram of the present preferred bandwidth allocation network with two network nodes 1502, 1506 and a monitor 1509 connected to a Digital Video Recorder 1508. Data from an audio source 1500 and a video source 1501 are connected to a network node 1502 which is connected to a local network 1507. Data from a second audio source 1503, a second video source 1504 and a control data source 1505 are connected to a second network node 1506 which is connected to the local network 1507. Both network nodes 1502, 1506 communicate over the local network 1507 to a master node with a Digital Video Recorder (DVR) 1508. The master node with DVR 1508 can also perform the same function as a network node 1502, 1506. The master node with the DVR 1508 controls such parameters as how much bandwidth is allocated, the types of compression, and the compression rates, compression parameters, and data rate reduction parameters, associated with all the data sources 1500, 1501, 1503, 1504, 1505 based on the available bandwidth of the local network 1507, system settings, and user settings. The data from the video, audio, and data sources 1500, 1501, 1503, 1504, and 1505 is sent from the master node with the DVR 1508 to the monitor 1509 and/or the DVR 1508 for storage.

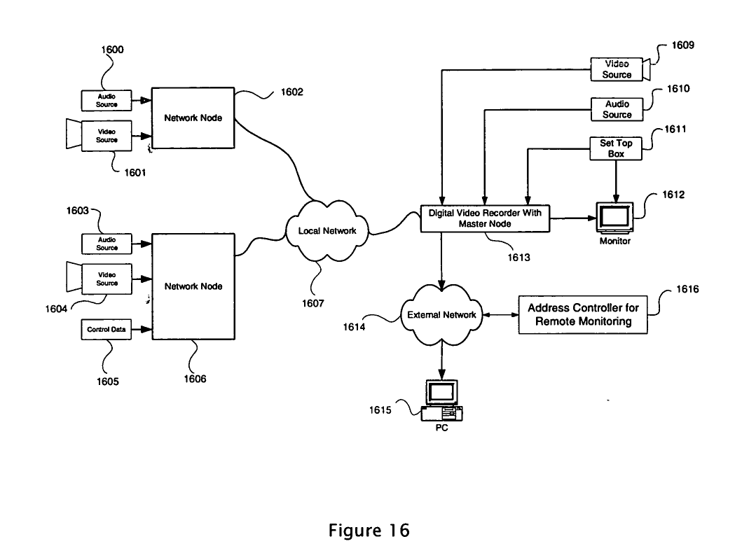

FIG. 16 is a block diagram of the present preferred bandwidth allocation network with two network nodes 1602, 1606 and a Digital Video Recorder 1613 with a variety of locally attached devices with an external network connection. Data from an audio source 1600 and a video source 1601 are connected to a network node 1602 which is connected to a local network 1607. Data from a second audio source 1603, a second video source 1604 and a control data source 1605 are connected to a second network node 1606 which is connected to the local network 1607. Both network nodes 1602, 1606 communicate over the local network 1607 to a master node with a Digital Video Recorder (DVR) 1613. The master node with the DVR 1613 can also perform the same function as a network node 1602, 1606. The master node with the DVR 1613 is connected to a third video source 1609, a third audio source 1610, and a set top box 1611. The master node with the DVR 1613 controls such parameters as how much bandwidth is allocated, the types of compression, and the compression rates, compression parameters, and data rate reduction parameters, for all the data sources 1600, 1601, 1603, 1604, 1605, 1609, 1610, 1611, based on the available bandwidth of the local network 1607, system settings, and user settings. A monitor 1612 is connected to the master node with the DVR 1613. The monitor 1612 is used to view data from the data sources 1600, 1601, 1603, 1604, 1605, 1609, 1610, 1611, and/or configure the master node with the DVR 1613. The data from the video, audio, and data sources 1600, 1601, 1603, 1604, 1605, 1609, 11610, 1611, is sent from the master node with the DVR 1613 to the monitor 1509 and/or the DVR 1508 for storage. In addition, the data from the data streams 1600, 1601, 1603, 1604, 1605, 1609, 1610, 1611, can be sent to the personal computer 1615 over the external network 1614 and/or the address controller 1515 which is used to coordinate addressing for remote monitoring.

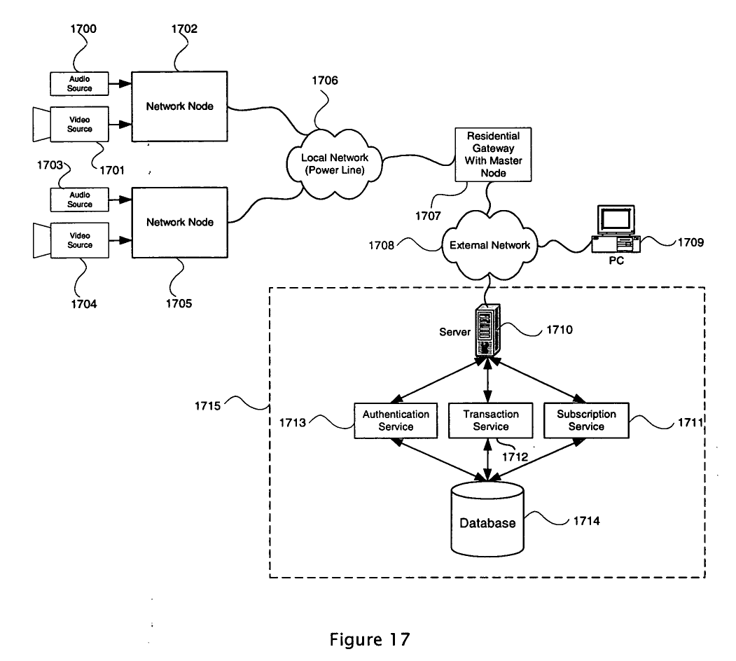

FIG. 17 is a block diagram of the present preferred bandwidth allocation network with two network nodes 1702, 1705, and a residential gateway with a master node 1707 which is connected to an address controller 1715 and a PC 1709. The residential gateway with a master node 1707 can be stand alone, contained within a PC in part or whole, or contained within a DVR in part or whole. Data from an audio source 1700 and a video source 1701 are connected to a network node 1702 which is connected to a local network 1706. Data from a second audio source 1703, a second video source 1704 are connected to a second network node 1705 which is connected to the local network 1706. Both network nodes 1702, 1705 communicate over the local network 1706 to a master node with a residential gateway 1707. The master node with the residential gateway 1707 can also perform the same function as a network node 1702, 1705. The master node with the residential gateway 1707 controls such parameters as how much bandwidth is allocated, the types of compression, and the compression rates, compression parameters, and data rate reduction parameters, for all the data sources 1700, 1701, 1703, 1704, based on the available bandwidth of the local network 1706, system settings, and user settings. The data from the video and audio sources 1700, 1701, 1703, 1704, can be sent from the master node with the residential gateway 1707 to the personal computer 1709 over the external network 1708. In addition, the data from the data streams 1700, 1701, 1703, 1704, to a remote monitoring station coordinated by the address controller 1715. The address controller 1715 includes server 1710 that contains an authentication service 1713 which allows users to authenticate and gain access to the data sources 1700, 1701, 1703, and 1704. The address controller 1715 also includes a transaction service 1712 for tracking access from users who have logged in using the authentication service 1713. The transaction service 1712 is used to enable and/or bill the users who have logged on a per access and/or time basis. The subscription service 1711 is used to facilitate remote user connections, protect remote users and/or bill users based on a periodic rate such as monthly rate, a weekly rate, a yearly rate, and the like. If a user has subscribed using the subscription service 1711, users are granted access if their accounts are valid and/or subscriptions are paid. Information for the authentication service 1713, the transaction service 1712, and the subscription service 1711 are stored in the database 1714. A user can authenticate to the address controller 1715 from a personal computer 1709 by providing a password and master node identifier. Once user credentials are validated, a connection to the residential gateway with a master node 1707 is made using the user supplied credentials. The connections to and from the address controller 1715 can be encrypted to ensure security on the external network 1708. The user which has requested access from the personal computer 1707 can now view and/or listen to the information from the data streams 1700, 1701, 1703, and 1704. Information obtained from the transaction service 1712 and/or the subscription service 1711 is used to provide statistics and/or billing information and/or protection and/or convenience for the users and/or administrators of the address service.

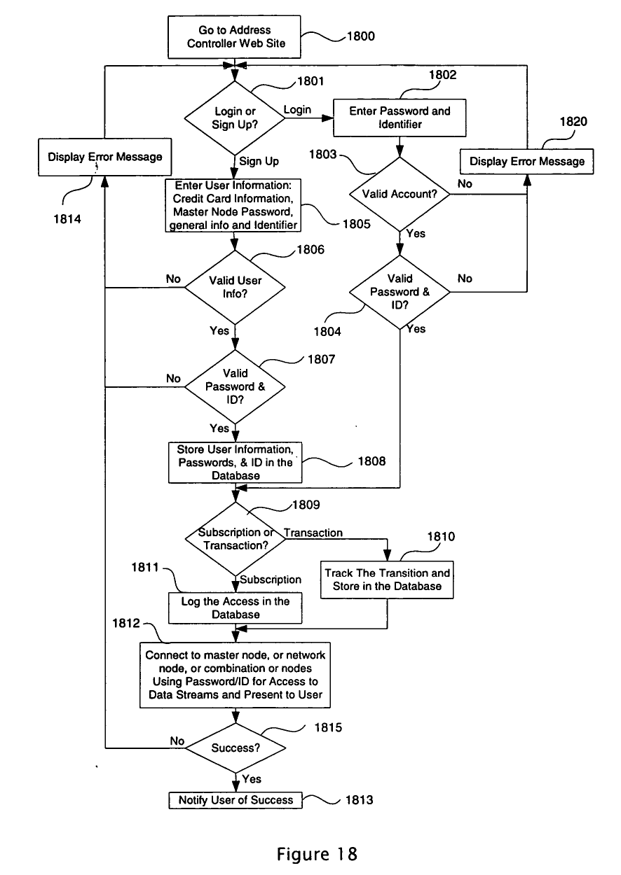

FIG. 18 is a flow diagram of the present preferred method of adding, authenticating and providing access to a bandwidth allocation system using an address controller. The process begins when a user accesses 1800 the address controller 1715 web site. The user is asked 1801 if they want to login or sign up for the address service 1715. If the user is signing up for the address service 1715 in test 1801, the user enters 1805 the user's information which may include some or all of, general information, password, identifier, and if the service is a paid subscription service credit card information. The password and identifier are supplied to the user who qualifies for the service with an appropriate master node 1707. The authentication service 1713 checks 1806 to make sure the user's information are filled out and valid. If the information is not valid in test 1806, the authentication service 1713 displays an error message 1814 and requests 1801 the user to login or sign up. Otherwise, if test 1806 is yes, the authentication service 1713 determines 1807 if the password and Identifier are valid. The password and the gateway identifier and stored in the database 1714 and compared with the password and identifier from the gateway when it becomes active on the external network 1708. If the password and identifier are not valid in test 1807, the authentication service 1713 displays 1814 an error message and requests 1801 the user to login or sign up. Otherwise, if test 1807 is yes, the authentication service 1713 stores 1808 the user information, password, and Identifier in the database 1714. The process determines 1809 if the user is using a subscription service 1711 or a transaction service 1712. If the user is using a transaction service 1712, the transaction service 1712 tracks the time, number of accesses, and stores the information in the database 1714. Otherwise, if the user is using a subscription service 1711, the subscription service 1711 logs the access and stores the information in the database 1714. The process enables and/or facilitates a connection to the residential gateway with master node and/or network node or nodes, 1707 1702, 1705 using the password and identifier for access 1812. If the address controller 1715 cannot connect to the residential gateway with master node 1707, the process displays an error message 1814 and requests 1801 the user to login or sign up. Otherwise, if test 1815 is successful, the process notifies 1813 the user of access to the residential gateway with the master node 1707 and can view/listen to the data streams from the data sources 1700, 1701, 1703, and 1704. If the user has already signed up and is just wants to log in to the address controller 1715, in test 1801, the authentication service 1713 requests the user to enter 1802 the password and identifier. The authentication service 1713 checks 1803 for a valid account. If the account is not valid in test 1803, the authentication service 1703 displays an error message 1820 and requests 1801 the user to login or signup. Otherwise, if test 1803 is yes, the authentication service 1713 checks 1804 for a valid password and identifier. If the password and/or the identifier are invalid in test 1804, the authentication service 1713, displays an error message 1820 and requests 1801 the user to login or signup. Otherwise, if test 1804 is yes the process checks 1809 to see if the user selected a subscription service 1711 or a transaction service 1712.

In addition, these bandwidth allocation methods can be implemented using a variety of process, but are not limited to computer hardware, microcode, firmware, software, and the like.

The described embodiments of this invention are to be considered in all respects only as illustrative and not as restrictive. Although specific flow diagrams system diagrams are provided, the invention is not limited thereto. The scope of this invention is, therefore, indicated by the claims rather than the foregoing description. All changes, which come within the meaning and range of equivalency of the claims, are to be embraced within their scope.

1. A system for allocating bandwidth on a network comprising:
A. one or more network nodes wherein said one or more network nodes further comprises a first processing element, a compression module, a first local network interface, and a first bandwidth adjustment module, wherein said compression module further comprises a plurality of compression parameters and said first processing element controls said bandwidth adjustment module, said first local network interface, and said compression module;
B. a data interface connected to said one or more network nodes;
C. a master node wherein said master node further comprises a second processing element, a second local network interface, and a second bandwidth adjustment module and wherein said second processing element controls said second network interface and said second bandwidth adjustment module;
D. wherein said one or more network nodes and said master node communicate using said first local network interface and said second network interface; and
E. wherein said second bandwidth adjustment module dynamically changes at least one of said compression parameters in said first bandwidth adjustment module based on network conditions on the local network wherein said network conditions are detected by said second local network interface.

2. A system for allocating bandwidth on a network as recited in claim 1 wherein said compression parameters are parameters selected from the group consisting of compression ratios, compression types, picture quality, picture resolution, audio quality, color content and color space separation.

3. A system for allocating bandwidth on a network as recited in claim 2 wherein types of said compression types are compression types selected from the group consisting of MJPEG, MPEG1, MPEG2, MPEG4, MPEG7, MPEG10, H.263, H.264, H.323, Windows Media Video 9 (WMv-9), wavelet compression, compression with post smoothing techniques, AC-3, DTS, AAC, G.711, G.723, G.729, GSM-AMR, Broadband GSM-AMR, and MP3.

4. A system for allocating bandwidth on a network as recited in claim 1 wherein said network conditions are a network condition selected from the group consisting of obstructions, RF interference, changing network impedance, impedance mismatches, RF harmonics, multipath effects, various channel fading effects, network traffic volume, conducted noise, induced noise, self induced noise, friendly noise, and intermodulation products.

5. A system for allocating bandwidth on a network as recited in claim 1 wherein said master node further comprises a decompression module for decompressing data compressed by said compression module.

6. A system for allocating bandwidth on a network as recited in claim 1 wherein a data source is connected to said data interface and said data source is a data source selected from the group consisting of a video source, an audio source, a computer data stream, control data, and telephony data.

7. A system for allocating bandwidth on a network as recited in claim 1 wherein a data source is connected to said data interface and wherein said data interface is a data interface selected from the group consisting of PAL composite, PAL component video, NTSC composite video, NTSC component video, S-video, serial, I²C, SPI, DVI, Digital Camera Interface, CCIR656, CCIR601, UTI656, UTI601, and Parallel.

8. A system for allocating bandwidth on a network as recited in claim 1 wherein an attribute of a data source is controlled from said data interface wherein said attribute is selected from the group consisting of brightness, contrast, hue, white balance, saturation, luminance decimation filtering, n tap interpolation horizontal scaling, and n tap interpolation vertical scaling.

9. A system for allocating bandwidth on a network as recited in claim 1 wherein said one or more network nodes further comprise a motion detector which detects changes in motion of said video source.

10. A system for allocating bandwidth on a network as recited in claim 9 wherein said motion detector detects changes in motion while applying a motion mask having motion mask parameters, wherein said motion mask parameters are selected from a group consisting of user determined, automatically learned, defined as geometric shapes, defined as non-geometric shapes, defined by regions, defined by object size, defined by object speed, defined by object micro movements, and defined by object macro movements.

11. A system for allocating bandwidth on a network as recited in claim 1 wherein said one or more network nodes further comprise a mass storage device to store data received on said data interface based on said network conditions.

12. A system for allocating bandwidth on a network as recited in claim 11 wherein said mass storage device is a device selected from the group consisting of a hard disk, solid state flash memory, solid state random access memory, a high capacity floppy disk, and magnetic tape.

13. A system for allocating bandwidth on a network as recited in clam 11 wherein said mass storage device is removable.

14. A system for allocating bandwidth on a network as recited in claim 1 wherein said one or more network nodes further comprise an encryption/decryption module for encrypting and decrypting data received on said data interface.

15. A system for allocating bandwidth on a network as recited in claim 14 wherein said encryption/decryption module encrypts data on said local network and an external network.

16. A system for allocating bandwidth on a network as recited in claim 1 wherein said one or more network nodes further comprise a web server for administration of said one or more network nodes.

17. A system for allocating bandwidth on a network as recited in claim 1 wherein said one or more network nodes further comprise a remote address client for communicating with a remote address controller for remote monitoring over an external network.

18. A system for allocating bandwidth on a network as recited in claim 1 wherein said master node further comprises a mass storage device to store data received on said data interface.

19. A system for allocating bandwidth on a network as recited in claim 18 wherein said mass storage device is a device selected from the group consisting of a hard disk, solid state flash memory, solid state random access memory, a high capacity floppy disk, and magnetic tape.

20. A system for allocating bandwidth on a network as recited in claim 1 wherein said master node further comprises an encryption/decryption module for decrypting data received from said data interface.

21. A system for allocating bandwidth on a network as recited in claim 20 wherein said encryption module supports an encryption method selected from the group consisting of DES, Triple DES, AES, RC4, RC5, 56 Bit, 64 Bit, 128 Bit, and RSA.

22. A system for allocating bandwidth on a network as recited in claim 1 wherein said master node further comprises a web server for administration of said master node.

23. A system for allocating bandwidth on a network as recited in claim 1 wherein said master node further comprises an application program and a decompression module which decompresses the data from said compression module and data from said decompression module is used by said application program.

24. A system for allocating bandwidth on a network as recited in claim 1 further comprising an external network connected to said master node.

25. A system for allocating bandwidth on a network as recited in claim 24 further comprising a remote monitoring station connected to said external network wherein said remote monitor station receives data from said data interface.

26. A system for allocating bandwidth on a network as recited in claim 24 wherein said external network is a network selected from the group consisting of the Internet, a Local Area Network (LAN), and a Wide Area Network (WAN).

27. A system for allocating bandwidth on a network as recited in claim 1 wherein said first local network interface and said second local network interface communicate over a network selected from the group consisting of a power line network, a wireless network, an acoustic network, a wired network, and an optic network.

28. A system for allocating bandwidth on a network as recited in claim 1 wherein said first processing element and said second processing element communicate over a network using a protocol selected from the group consisting of RTSP, RTP, RTCP, HTTP, ASF, FTP, DDNS, NTP TFTP, TCP/IP, UDP, DHCP, DNS, SMTP, HTML, LDAP, SNMP and SNTP.

29. A system for allocating bandwidth on a network as recited in claim 1 wherein said first processing element inserts information into a data stream from said data interface wherein said information is selected from the group consisting of a time stamp and a watermark.

30. A system for allocating bandwidth on a network as recited in claim 1 wherein a device connected to said master node is a device selected from the group consisting of a personal computer, a telephone, an e-mail system, a monitor, and a digital video recorder.

31. A system for allocating bandwidth on a network as recited in claim 1 wherein a signal is generated based on changes in said data stream.

32. A system for allocating bandwidth on a network as recited in claim 31 wherein said signal is a signal selected from the group consisting of an e-mail, a text message, a voice message, a lighting control signal, a video control signal, and an audio control signal.

33. A system for allocating bandwidth on a network as recited in claim 1 further comprising a temperature sensor connected to said local network and wherein said master node reads temperature from said temperature sensor.

34. A system for allocating bandwidth on a network as recited in claim 1 wherein said compression parameters are controlled based on a constant network load.

35. A system for allocating bandwidth on a network as recited in claim 1 wherein said compression parameters are controlled based on a constant media stream rate above a threshold.

36. A system for allocating bandwidth on a network as recited in claim 1 wherein said compression parameters are controlled based on a constant media stream rate above a threshold with intermediate streaming.

37. A system for allocating bandwidth on a network as recited in claim 1 wherein said master node is a software application running in a personal computer.

38. A system for allocating bandwidth on a network as recited in claim 1 wherein said one or more network nodes is a software application running in a personal computer.

39. A system for allocating bandwidth on a network comprising:
A. a first of network node wherein said first network node further comprises a first processing element, a first bandwidth adjustment module, a first local network interface, and a compression module wherein said compression module contains a plurality of compression parameters and wherein said first processing element controls said first bandwidth adjustment module, said first local network interface, and said compression module;
B. a data interface connected to said first network node;
C. a second network node wherein said second network node further comprises a second processing element, a second bandwidth adjustment module, a second local network interface, and wherein said second processing element controls said second local network interface and said second bandwidth adjustment module
D. wherein said first network node and said second network node electronically communicate using said first local network interface and said second local network interface; and
E. wherein said second bandwidth adjustment module dynamically changes at least one of said compression parameters in said first bandwidth adjustment module based on network conditions on the local network wherein said network conditions are detected by said second local network interface.

40. A system for allocating bandwidth on a network as recited in claim 39 wherein said compression parameters are parameters selected from the group consisting of compression ratios, compression types, picture quality, picture resolution, audio quality, color content, water mark, time stamp, and color space separation.

41. A system for allocating bandwidth on a network as recited in claim 40 wherein types of said compression types are compression types selected from the group consisting of MJPEG, MPEG1, MPEG2, MPEG4, MPEG7, MPEG10, H.263, H.264, H.323, Windows Media Video 9 (WMv-9), wavelet compression, compression with post smoothing techniques, AC-3, DTS, AAC, G.711, G.723, G.729, GSM-AMR, Broadband GSM-AMR, and MP3.

42. A system for allocating bandwidth on a network as recited in claim 39 wherein said network conditions are a network condition selected from the group consisting of obstructions, RF interference, changing network impedance, impedance mismatches, RF harmonics, multipath effects, various channel fading effects, network traffic volume, conducted noise, induced noise, self induced noise, friendly noise, and intermodulation products.

43. A system for allocating bandwidth on a network as recited in claim 39 wherein said first or second network node further comprises a decompression module for decompressing data compressed by said compression module.

44. A system for allocating bandwidth on a network as recited in claim 39 wherein a data source is connected to said data interface and said data source is a data source selected from the group consisting of a video source, an audio source, a computer data stream, control data, and telephony data.

45. A system for allocating bandwidth on a network as recited in claim 39 wherein a data source is connected to said data interface and wherein said data interface is a data interface selected from the group consisting of PAL composite, PAL component video, NTSC composite video, NTSC component video, S-video, serial, I²C, SPI, DVI, Digital Camera Interface, CCIR656, CCIR601, UTI656, UTI601, and Parallel.

46. A system for allocating bandwidth on a network as recited in claim 39 wherein an attribute of a data source is controlled from said data interface wherein said attribute is selected from the group consisting of brightness, contrast, hue, white balance, saturation, luminance decimation filtering, n tap interpolation horizontal scaling, and n tap interpolation vertical scaling.

47. A system for allocating bandwidth on a network as recited in claim 39 wherein said first or second network nodes further comprise a motion detector which detects changes in motion of said video source.

48. A system for allocating bandwidth on a network as recited in claim 47 wherein said motion detector detects changes in motion while applying a motion mask wherein the mask parameters are selected from a group consisting of user determined, automatically learned, defined as geometric shapes, defined as non-geometric shapes, defined by regions, defined by object size, defined by object speed, defined by object micro movements, and defined by object macro movements.

49. A system for allocating bandwidth on a network as recited in claim 39 wherein said first or second network nodes further comprise a mass storage device to store data received on said data interface based on said network conditions.

50. A system for allocating bandwidth on a network as recited in claim 49 wherein said mass storage device is a device selected from the group consisting of a hard disk, solid state flash memory, solid state random access memory, a high capacity floppy disk, and magnetic tape.

51. A system for allocating bandwidth on a network as recited in clam 49 wherein said mass storage device is removable.

52. A system for allocating bandwidth on a network as recited in claim 39 wherein said first or second network nodes further comprise an encryption/decryption module for encrypting and decrypting data received on said data interface.

53. A system for allocating bandwidth on a network as recited in claim 52 wherein said encryption/decryption module encrypts data on said local network and an external network.

54. A system for allocating bandwidth on a network as recited in claim 39 wherein said first or second network nodes further comprise a web server for administration of said one or more network nodes.

55. A system for allocating bandwidth on a network as recited in claim 39 wherein said first or second network nodes further comprise a remote address client for communicating with a remote address controller for remote monitoring over an external network.

56. A system for allocating bandwidth on a network as recited in claim 39 wherein said first or second network node further comprises an encryption/decryption module for decrypting data received from said data interface.

57. A system for allocating bandwidth on a network as recited in claim 56 wherein said encryption module supports an encryption method selected from the group consisting of DES, Triple DES, AES, RC4, RC5, 56 Bit, 64 Bit, 128 Bit, and RSA.

58. A system for allocating bandwidth on a network as recited in claim 39 wherein said first or second network node further comprises an application program and a decompression module which decompresses the data from said compression module and data from said decompression module is used by said application program.

59. A system for allocating bandwidth on a network as recited in claim 39 further comprising an external network connected to said first or second network node.

60. A system for allocating bandwidth on a network as recited in claim 59 further comprising a remote monitor station connected to said external network wherein said remote monitor station receives data from said data interface.

61. A system for allocating bandwidth on a network as recited in claim 59 wherein said external network is a network selected from the group consisting of the Internet, a Local Area Network (LAN), and a Wide Area Network (WAN).

62. A system for allocating bandwidth on a network as recited in claim 39 wherein said first local network interface and said second local network interface communicate over a network selected from the group consisting of a power line network, a wireless network, an acoustic network, a wired network, and an optic network.

63. A system for allocating bandwidth on a network as recited in claim 39 wherein said first processing element and said second processing element communicate over a network using a protocol selected from the group consisting of RTSP, RTP, RTCP, HTTP, ASF, FTP, DDNS, NTP TFTP, TCP/IP, UDP, DHCP, DNS, SMTP, HTML, LDAP, SNMP and SNTP.

64. A system for allocating bandwidth on a network as recited in claim 39 wherein said first processing element inserts information into a data stream from said data interface wherein said information is selected from the group consisting of a time stamp and a watermark.

65. A system for allocating bandwidth on a network as recited in claim 39 wherein a device connected to said master node is a device selected from the group consisting of a personal computer, a telephone, an e-mail system, a monitor, and a digital video recorder.

66. A system for allocating bandwidth on a network as recited in claim 39 wherein a signal is generated based on changes in said data stream.

67. A system for allocating bandwidth on a network as recited in claim 66 wherein said a signal is an a signal selected from the group consisting of an e-mail, a text message, a voice message, a lighting control signal, a video control signal, and an audio control signal.

68. A system for allocating bandwidth on a network as recited in claim 39 further comprising a temperature sensor connected to said local network and wherein said master node reads temperature from said temperature sensor.

69. A system for allocating bandwidth on a network as recited in claim 39 wherein said compression parameters are controlled based on a constant network load.

70. A system for allocating bandwidth on a network as recited in claim 39 wherein said compression parameters are controlled based on a constant media stream rate above a threshold.

71. A system for allocating bandwidth on a network as recited in claim 39 wherein said compression parameters are controlled based on a constant media stream rate above a threshold with intermediate streaming.

72. A system for allocating bandwidth on a network as recited in claim 39 wherein said master node is a software application running in a personal computer.

73. A system for allocating bandwidth on a network as recited in claim 39 wherein said one or more network nodes is a software application running in a personal computer.

74. A data address controller system comprising:
A. one or more network nodes wherein said one or more network nodes further comprises a processing element, a compression module, a local network interface, a remote address client, and a bandwidth adjustment module, wherein said compression module contains a plurality of compression parameters and said processing element controls said bandwidth adjustment module, said local network interface, and said compression module;
B. a data interface connected to said one or more network nodes;
C. an address controller connected to said one or more network nodes over a network; and
D. wherein authentication is granted to said address controller and wherein said address controller connects to said remote access client which allows said access to data received on said data interface.

75. A data address controller system as recited in claim 74 wherein said address controller further comprises a database for storing authentication information.

76. A data address controller system as recited in claim 74 wherein said address controller further comprises a transaction service and a database for storing transaction information.

77. A data address controller system as recited in claim 74 wherein said address controller further comprises a subscription service and a database for storing subscription information.

78. A method for allocating bandwidth on a network comprising the steps of:
A. receiving data on a data interface on a network node which comprises a first bandwidth adjustment module, a first local network interface, and a compression module with a plurality of compression parameters;
B. sampling network conditions from a second local network interface with a second bandwidth adjustment module in a master node;
C. determining the bandwidth requirements for data received on said data interface based on said network conditions in said second bandwidth adjustment module; and
D. notifying said first bandwidth adjustment module of said bandwidth requirements which causes said network node to change said compression parameters for said received data.

79. A method for allocating bandwidth on a network as recited in claim 78 wherein said compression parameters are compression parameters selected from the group consisting of compression ratios, compression types, picture quality, picture resolution, audio quality, color content, water mark, time stamp, and color space separation.

80. A method for allocating bandwidth on a network as recited in claim 79 wherein said compression types are compression types selected from the group consisting of MJPEG, MPEG1, MPEG2, MPEG4, MPEG7, MPEG10, H.263, H.264, H.323, Windows Media Video 9 (WMv-9), wavelet compression, compression with post smoothing techniques, AC-3, DTS, AAC, G.711, G.723, G.729, GSM-AMR, Broadband GSM-AMR, and MP3.

81. A method for allocating bandwidth on a network as recited in claim 78 wherein said network conditions are a network condition selected from the group consisting of obstructions, RF interference, changing network impedance, impedance mismatches, RF harmonics, multipath effects, various channel fading effects, network traffic volume, conducted noise, induced noise, self induced noise, friendly noise, and intermodulation products.

82. A method for allocating bandwidth on a network as recited in claim 78 wherein said master node further comprises a decompression module for decompressing data compressed by said compression module.

83. A method for allocating bandwidth on a network as recited in claim 78 wherein a data source is connected to said data interface and said data source is a data source selected from the group consisting of a video source, an audio source, a computer data stream, control data, and telephony data.

84. A method for allocating bandwidth on a network as recited in claim 78 wherein a data source is connected to said data interface and wherein said data interface is a data interface selected from the group consisting of PAL composite, PAL component video, NTSC composite video, NTSC component video, S-video, serial, I²C, SPI, DVI, Digital Camera Interface, CCIR656, CCIR601, UTI656, UTI601, and Parallel.

85. A method for allocating bandwidth on a network as recited in claim 78 wherein an attribute of a data source is controlled from said data interface wherein said attribute is selected from the group consisting of brightness, contrast, hue, white balance, saturation, luminance decimation filtering, n tap interpolation horizontal scaling, and n tap interpolation vertical scaling.

86. A method for allocating bandwidth on a network as recited in claim 78 wherein said network node further comprise a motion detector which detects changes in motion of said video source.

87. A method for allocating bandwidth on a network as recited in claim 86 wherein said motion detector detects changes in motion while applying a motion mask wherein the mask parameters are selected from a group consisting of user determined, automatically learned, defined as geometric shapes, defined as non-geometric shapes, defined by regions, defined by object size, defined by object speed, defined by object micro movements, and defined by object macro movements.

88. A method for allocating bandwidth on a network as recited in claim 78 wherein said network node further comprise a mass storage device to store data received from said data interface based on said network conditions on said local network.

89. A method for allocating bandwidth on a network as recited in claim 88 wherein said mass storage device is a device selected from the group consisting of a hard disk, solid state flash memory, solid state random access memory, a high capacity floppy disk, and magnetic tape.

90. A method for allocating bandwidth on a network as recited in clam 88 wherein said mass storage device is removable.

91. A method for allocating bandwidth on a network as recited in claim 78 wherein said network node further comprises an encryption/decryption module for encrypting and decrypting data received from said data interface.

92. A method for allocating bandwidth on a network as recited in claim 91 wherein said encryption/decryption module encrypts data on said local network and an external network.

93. A method for allocating bandwidth on a network as recited in claim 78 wherein said network node further comprises a web server for administration of said network node.

94. A method for allocating bandwidth on a network as recited in claim 78 wherein said network node further comprises a remote address client for communicating with remote address controller for remote monitoring over an external network.

95. A method for allocating bandwidth on a network as recited in claim 78 wherein said master node further comprises a mass storage device to store data received from said data interface.

96. A method for allocating bandwidth on a network as recited in claim 95 wherein said mass storage device is a device selected from the group consisting of a hard disk, solid state flash memory, solid state random access memory, a high capacity floppy disk, and magnetic tape.

97. A method for allocating bandwidth on a network as recited in claim 78 wherein said master node further comprises an encryption/decryption module for decrypting data received from said data interface.

98. A method for allocating bandwidth on a network as recited in claim 99 wherein said encryption module supports an encryption method selected from the group consisting of DES, Triple DES, AES, RC4, RC5, 56 Bit, 64 Bit, 128 Bit, and RSA.

99. A method for allocating bandwidth on a network as recited in claim 78 wherein said master node further comprises a web server for administration of said master node.

100. A method for allocating bandwidth on a network as recited in claim 78 wherein said master node further comprises an application program and a decompression module which decompresses the data from said compression module and data from said decompression module is used by said application program.

101. A method for allocating bandwidth on a network as recited in claim 78 further comprising an external network connected to said master node.

102. A method for allocating bandwidth on a network as recited in claim 101 further comprising a remote monitor station connected to said external network wherein said remote monitor station receives data from said data interface.

103. A method for allocating bandwidth on a network as recited in claim 101 wherein said external network is a network selected from the group consisting of the Internet, a Local Area Network (LAN), and a Wide Area Network (WAN).

104. A method for allocating bandwidth on a network as recited in claim 78 wherein said first local network interface and said second local network interface communicate over a network selected from the group consisting of a power line network, a wireless network, an acoustic network, a wired network, and an optic network.

105. A method for allocating bandwidth on a network as recited in claim 78 wherein said first processing element and said second processing element communicate over a network using a protocol selected from the group consisting of RTSP, RTP, RTCP, HTTP, ASF, FTP, DDNS, NTP TFTP, TCP/IP, UDP, DHCP, DNS, SMTP, HTML, LDAP, SNMP and SNTP.

106. A method for allocating bandwidth on a network as recited in claim 78 wherein said first processing element inserts information into a data stream from said data interface wherein said information is selected from the group consisting of a time stamp and a watermark.

107. A method for allocating bandwidth on a network as recited in claim 78 wherein a device connected to said master node is a device selected from the group consisting of a personal computer, a telephone, an e-mail system, a monitor, and a digital video recorder.

108. A method for allocating bandwidth on a network as recited in claim 78 wherein a signal is generated based on changes in the data received on said data interface.

109. A method for allocating bandwidth on a network as recited in claim 108 wherein said a signal is an a signal selected from the group consisting of an e-mail, a text message, a voice message, a lighting control signal, a video control signal, and an audio control signal.

110. A method for allocating bandwidth on a network as recited in claim 78 further comprising a temperature sensor connected to said local network and wherein said master node reads temperature from said temperature sensor.

111. A method for allocating bandwidth on a network as recited in claim 78 wherein said compression parameters are controlled based on a constant network load.

112. A method for allocating bandwidth on a network as recited in claim 78 wherein said compression parameters are controlled based on a constant media stream rate above a threshold.

113. A method for allocating bandwidth on a network as recited in claim 78 wherein said compression parameters are controlled based on a constant media stream rate above a threshold with intermediate streaming.

114. A method for allocating bandwidth on a network comprising:
A. receiving data on a data interface on a first network node which comprises a first bandwidth adjustment module, a first local network interface, and a compression module with a plurality of compression parameters;
B. sampling network conditions from a second local network interface with a second bandwidth adjustment module in a second network node;
C. determining the bandwidth requirements for data received on said data interface based on said network conditions in said second bandwidth adjustment module; and
D. notifying said first bandwidth adjustment module of said bandwidth requirements which causes said first network node to change said compression parameters for said received data.

115. A method for allocating bandwidth on a network as recited in claim 114 wherein said compression parameters are compression parameters selected from the group consisting of compression ratios, compression types, picture quality, picture resolution, audio quality, color content, water mark, time stamp, and color space separation.

116. A method for allocating bandwidth on a network as recited in claim 115 wherein said compression types are compression types selected from the group consisting of MJPEG, MPEG1, MPEG2, MPEG4, MPEG7, MPEG10, H.263, H.264, H.323, Windows Media Video 9 (WMv-9), wavelet compression, compression with post smoothing techniques, AC-3, DTS, AAC, G.711, G.723, G.729, GSM-AMR, Broadband GSM-AMR, and MP3.

117. A method for allocating bandwidth on a network as recited in claim 114 wherein said network conditions are a network condition selected from the group consisting of obstructions, RF interference, changing network impedance, impedance mismatches, RF harmonics, multipath effects, various channel fading effects, network traffic volume, conducted noise, induced noise, self induced noise, friendly noise, and intermodulation products.

118. A method for allocating bandwidth on a network as recited in claim 114 wherein said first or second network nodes further comprises a decompression module for decompressing data compressed by said compression module.

119. A method for allocating bandwidth on a network as recited in claim 114 wherein a data source is connected to said data interface and said data source is a data source selected from the group consisting of a video source, an audio source, a computer data stream, control data, and telephony data.

120. A method for allocating bandwidth on a network as recited in claim 114 wherein a data source is connected to said data interface and wherein said data interface is a data interface selected from the group consisting of PAL composite, PAL component video, NTSC composite video, NTSC component video, S-video, serial, I²C, SPI, DVI, Digital Camera Interface, CCIR656, CCIR601, UTI656, UTI601, and Parallel.

121. A method for allocating bandwidth on a network as recited in claim 114 wherein an attribute of a data source is controlled from said data interface wherein said attribute is selected from the group consisting of brightness, contrast, hue, white balance, saturation, luminance decimation filtering, n tap interpolation horizontal scaling, and n tap interpolation vertical scaling.

122. A method for allocating bandwidth on a network as recited in claim 114 wherein said first or second network node further comprise a motion detector which detects changes in motion of said video source.

123. A method for allocating bandwidth on a network as recited in claim 122 wherein said motion detector detects changes in motion while applying a motion mask wherein the mask parameters are selected from a group consisting of user determined, automatically learned, defined as geometric shapes, defined as non-geometric shapes, defined by regions, defined by object size, defined by object speed, defined by object micro movements, and defined by object macro movements.

124. A method for allocating bandwidth on a network as recited in claim 114 wherein said first or second network node further comprise a mass storage device to store data received from said data interface based on said network conditions on said local network.

125. A method for allocating bandwidth on a network as recited in claim 124 wherein said mass storage device is a device selected from the group consisting of a hard disk, solid state flash memory, solid state random access memory, a high capacity floppy disk, and magnetic tape.

126. A method for allocating bandwidth on a network as recited in clam 124 wherein said mass storage device is removable.

127. A method for allocating bandwidth on a network as recited in claim 114 wherein said first or second network node further comprises an encryption/decryption module for encrypting and decrypting data received from said data interface.

128. A method for allocating bandwidth on a network as recited in claim 114 wherein said encryption/decryption module encrypts data on said local network and an external network.

129. A method for allocating bandwidth on a network as recited in claim 114 wherein said encryption module supports an encryption method selected from the group consisting of DES, Triple DES, AES, RC4, RC5, 56 Bit, 64 Bit, 128 Bit, and RSA.

130. A method for allocating bandwidth on a network as recited in claim 114 wherein said first or second network node further comprises a web server for administration of said network node.

131. A method for allocating bandwidth on a network as recited in claim 114 wherein said first or second network node further comprises a remote address client for communicating with remote address controller for remote monitoring over an external network.

132. A method for allocating bandwidth on a network as recited in claim 114 wherein said first or second network node further comprises an application program and a decompression module which decompresses the data from said compression module and data from said decompression module is used by said application program.

133. A method for allocating bandwidth on a network as recited in claim 114 further comprising an external network connected to said master node.

134. A method for allocating bandwidth on a network as recited in claim 133 further comprising a remote monitor station connected to said external network wherein said remote monitor station receives data from said data interface.

135. A method for allocating bandwidth on a network as recited in claim 133 wherein said external network is a network selected from the group consisting of the Internet, a Local Area Network (LAN), and a Wide Area Network (WAN).

136. A method for allocating bandwidth on a network as recited in claim 114 wherein said first local network interface and said second local network interface communicate over a network selected from the group consisting of a power line network, a wireless network, an acoustic network, a wired network, and an optic network.

137. A method for allocating bandwidth on a network as recited in claim 114 wherein a device connected to said first or second network node is a device selected from the group consisting of a personal computer, a telephone, an e-mail system, a monitor, and a digital video recorder.

138. A method for allocating bandwidth on a network as recited in claim 114 wherein a signal is generated based on changes in the data received on said data interface.

139. A method for allocating bandwidth on a network as recited in claim 138 wherein said a signal is an a signal selected from the group consisting of an e-mail, a text message, a voice message, a lighting control signal, a video control signal, and an audio control signal.

140. A method for allocating bandwidth on a network as recited in claim 114 further comprising a temperature sensor connected to said local network and wherein said master node reads temperature from said temperature sensor.

141. A method for allocating bandwidth on a network as recited in claim 114 wherein said compression parameters are controlled based on a constant network load.

142. A method for allocating bandwidth on a network as recited in claim 114 wherein said compression parameters are controlled based on a constant media stream rate above a threshold.

143. A method for allocating bandwidth on a network as recited in claim 114 wherein said compression parameters are controlled based on a constant media stream rate above a threshold with intermediate streaming.

144. A data address controller method comprising the steps of:
A. receiving data on a data interface on network node which comprises a bandwidth adjustment module, a network interface, and a remote access client;
B. authenticating to an address controller;
C. connecting said remote access client to said address controller over a network; and
D. providing access to data received on said data interface over said network.

145. A data address controller method as recited in claim 144 wherein said address controller further comprises a database for storing authentication information.

146. A data address controller method as recited in claim 144 wherein said address controller further comprises a transaction service and a database for storing transaction information.

147. A data address controller method as recited in claim 144 wherein said address controller further comprises a subscription service and a database for storing subscription information.
